(19) United States
(12) Patent Application Publication
(10) Pub. No.: US 2026/0331913 A1
(43) Pub. Date: Oct. 22, 2026

(54) POWER GRID RECOVERY METHOD AND APPARATUS OF NEW ELECTRIC POWER SYSTEM BASED ON SECOND-ORDER CONE TRANSFORMATION

(71) Applicants: STATE GRID HEBEI ELECTRIC POWER COMPANY ELECTRIC POWER RESEARCH INSTITUTE, Shijiazhuang (CN); STATE GRID CORPORATION OF CHINA, Beijing (CN)

(72) Inventors: Peng YANG, Shijiazhuang (CN); Tengkai YU, Shijiazhuang (CN); Jifeng LIANG, Shijiazhuang (CN); Xiaojun LI, Shijiazhuang (CN); Shiyang RONG, Shijiazhuang (CN); Leibao WANG, Shijiazhuang (CN); Jingyuan DONG, Shijiazhuang (CN); Qi ZHANG, Shijiazhuang (CN); Tongfei CUI, Shijiazhuang (CN); Rui ZHANG, Shijiazhuang (CN)

(21) Appl. No.: 18/861,715

(22) PCT Filed: Sep. 19, 2024
(86) PCT No.: PCT/CN2024/119653

§ 371 Date: Oct. 30, 2024

(30) Foreign Application Priority Data
Dec. 25, 2023 (CN) 202311798821.X

(51) Int. Cl. H02J 3/0014; H02J 3/38; H02J 3/48; H02J 3/50; H02J 101/28; H02J 103/35

(52) U.S. Cl. CPC H02J 3/0014; H02J 3/381; H02J 3/48; H02J 3/50; H02J 2101/28; H02J 2103/35

(57) ABSTRACT

Provided are a power grid recovery method and apparatus of a new electric power system based on a second-order cone transformation. The method includes that: electric power data of the new electric power system is acquired; a mixed integer non-linear two-stage robust optimization model based on a multi-state uncertain set is constructed based on the electric power data and in consideration of uncertainty of output power of a new energy unit; the alternating current power flow constraint is simplified by using a second-order cone relaxation technology, and the mixed integer non-linear two-stage robust optimization model is converted into a mixed integer second-order cone two-stage robust optimization model; the mixed integer second-order cone two-stage robust optimization model is decomposed into a master problem and the sub-problem to obtain an optimization result; and a power grid recovery solution of the new electric power system is generated based on the optimization result.

The present application claims priority to Chinese Patent Application No. 202311798821.X, filed with the China National Intellectual Property Administration (CNIPA) on Dec. 25, 2023, the disclosure of which is incorporated herein by reference in its entirety.

### TECHNICAL FIELD

The present application relates to the technical field of electric powers, for example, a power grid recovery method and apparatus of a new electric power system based on a second-order cone transformation.

### BACKGROUND

With the popularization of the related policies of “carbon peaking, carbon neutrality”, the proportion of grid connection and the output power of new energy, such as wind power and photovoltaic, in power grids in various regions is becoming increasingly large, and the construction of a new electric power system mainly based on new energy power generation has been rapidly developed, and the potential for accelerating the development has been presented. The occurrence of a power grid fault and a large-scale power failure event is difficult to avoid, and moreover, the fluctuation and controllability of the new energy power generation are poor, so that in the new system, the risk of local power failure or even large-scale power failure in the power grid is very high. Although the serious large-scale power failure accident of the power grid does not occur, measures of ordered power consumption and off-peak power consumption of different degrees have to be adopted in a few regions, so that an important load is preferentially ensured to supply power while ensuring the safe operation of the power grid. Therefore, the proportion of grid connection capacity and the output power of the new energy closely related to meteorological conditions is gradually improved, so that the operation and development of the power grid are more green environmental protection and sustainable, however, the risk of local power failure or even large-scale power failure of the power grid is increased to a certain extent, accordingly, it is necessary to respond aggressively to minimize the risk and loss of occurrence of malignant events such as the large-scale power failure.

A scientific and reasonable emergency plan taking the black start and system recovery solution as the core is the best measure for dealing with the large-scale power failure of the power grid. Based on this, the power supply of the power grid is able to be quickly recovered and political and economic losses caused by the power failure is able to be significantly reduced. With the construction of the new electric power system, new energy units may operate in an independent networking manner to achieve the active support and autonomous operation of the power grid and are potential black start power supplies. Therefore, in a regional power grid with a high proportion of new energy installations, the black start supporting capability of the new energy unit is able to be sufficiently developed. The study of adopting a new energy unit as a black start power supply after the power grid has serious faults not only provides a brand-new solution for system recovery and improves the recovery speed of the power grid and the load after the power grid has a major power failure, but also has important significance for shortening the failure power failure time and ensuring national energy safety and social stability.

In the new electric power system, the fluctuation of the power grid is increased due to randomness of output power and an amount of load recovery of the new energy. In the system recovery optimization problem, when an uncertainty variable fluctuates greatly, the objective function is difficult to decide, and a solving result cannot satisfy the actual requirements. Currently, in consideration of the uncertainties of output power and load requirements of new energy units in the system recovery process, the common methods include a random optimization method and a robust optimization method. The random optimization method needs to use a scene reduction strategy to obtain an approximate solution thereof, and it is difficult for the quality of the solving result and the solving speed to satisfy requirements at the same time. Whereas compared with the random optimization model, the robust optimization method model has the obvious advantages that uncertainty variable probability information which is difficult to accurately grasp is not needed, only operation range information of the uncertainty variable is needed, and the calculation speed is high, but the robust optimization method model can only adapt to the linear constraint, and the efficiency of the existing linear processing technology is low, so that the performance of the robust optimization method model is influenced. Therefore, there is an urgent need for an optimization method, which solves a problem that the conventional power grid recovery method is inefficient in linear processing technology by considering the uncertainty variable probability information of the output power of the new energy.

### SUMMARY

An embodiment of the present application provides a power grid recovery method and apparatus of a new electric power system based on a second-order cone transformation, so as to solve a problem that a conventional power grid recovery method is inefficient in linear processing technology by considering the uncertainty variable probability information of the output power of the new energy.

An embodiment of the present application provides a power grid recovery method of a new electric power system based on a second-order cone transformation. The method includes that: electric power data of the new electric power system is acquired; a mixed integer non-linear two-stage robust optimization model based on a multi-state uncertain set of the new electric power system is constructed based on the electric power data and in consideration of uncertainty of output power of a new energy unit, where the mixed integer non-linear two-stage robust optimization model includes an alternating current power flow constraint; the alternating current power flow constraint is simplified by using a second-order cone relaxation technology, and the mixed integer non-linear two-stage robust optimization model is converted into a mixed integer second-order cone two-stage robust optimization model; the mixed integer second-order cone two-stage robust optimization model is decomposed into a master problem and the sub-problem, and the master problem and the sub-problem are solved to obtain an optimization result; and a power grid recovery solution of the new electric power system is generated based on the optimization result.

An embodiment of the present application provides a power grid recovery apparatus of an electric power system based on a second-order cone transformation. The apparatus includes a data acquisition module, a model establishment module, a first calculation module, a second calculation module and a solution generation module. The data acquisition module is configured to acquire electric power data of a new electric power system. The model establishment module is configured to construct, based on the electric power data and in consideration of uncertainty of output power of a new energy unit, a mixed integer non-linear two-stage robust optimization model based on a multi-state uncertain set of the new electric power system, where the mixed integer non-linear two-stage robust optimization model includes an alternating current power flow constraint. The first calculation module is configured to simplify the alternating current power flow constraint by using a second-order cone relaxation technology, and convert the mixed integer non-linear two-stage robust optimization model into a mixed integer second-order cone two-stage robust optimization model. The second calculation module is configured to decompose the mixed integer second-order cone two-stage robust optimization model into a master problem and the sub-problem, and solve the master problem and the sub-problem to obtain an optimization result. The solution generation module is configured to generate a power grid recovery solution of the new electric power system based on the optimization result.

### BRIEF DESCRIPTION OF DRAWINGS

In order to describe embodiments of the present application, the drawings used for describing the embodiments will be introduced below. The drawings in the following description are merely some embodiments of the present application. For those of ordinary skill in the art, other drawings may also be obtained without creative labor according to these drawings.

FIG. 1 is a schematic flowchart of a power grid recovery method of a new electric power system based on a second-order cone transformation according to an embodiment of the present application;

FIG. 2A is a schematic diagram showing a state of a daily output power value of a first wind power plant according to an embodiment of the present application;

FIG. 2B is a schematic diagram showing a state of a daily output power value of a second wind power plant according to an embodiment of the present application;

FIG. 2C is a schematic diagram showing a state of a daily output power value of a third wind power plant according to an embodiment of the present application;

FIG. 3 is a schematic diagram of a system recovery condition of an IEEE39 node according to an embodiment of the present application;

FIG. 4 is a schematic diagram of a system recovery condition of an IEEE118 node according to an embodiment of the present application;

FIG. 5A is a schematic diagram of low non-linearization errors of all branches whose order of magnitude is 10⁻¹⁶ and whose IEEE118 node system is used as a research object according to an embodiment of the present application;

FIG. 5B is a schematic diagram of low non-linearization errors of all branches whose order of magnitude is 10⁻⁸ and whose IEEE118 node system is used as a research object according to an embodiment of the present application;

FIG. 6 is a schematic diagram of a relaxation error between a voltage and a phase angle according to an embodiment of the present application; and

FIG. 7 is a schematic structural diagram of a power grid recovery apparatus of an electric power system based on a second-order cone transformation according to an embodiment of the present application.

### DETAILED DESCRIPTION

In the following description, for the purpose of illustration rather than limitation, details such as a specific system structure and technology are provided to facilitate understanding of embodiments of the present application. However, it should be clear by those skilled in the art that the present application may be practiced in other embodiments without these details. In other instances, descriptions of well-known systems, apparatuses, circuits, and methods are omitted to avoid unnecessary details from obstructing the description of the present application.

The following description will be made by way of the embodiments in conjunction with the accompanying drawings.

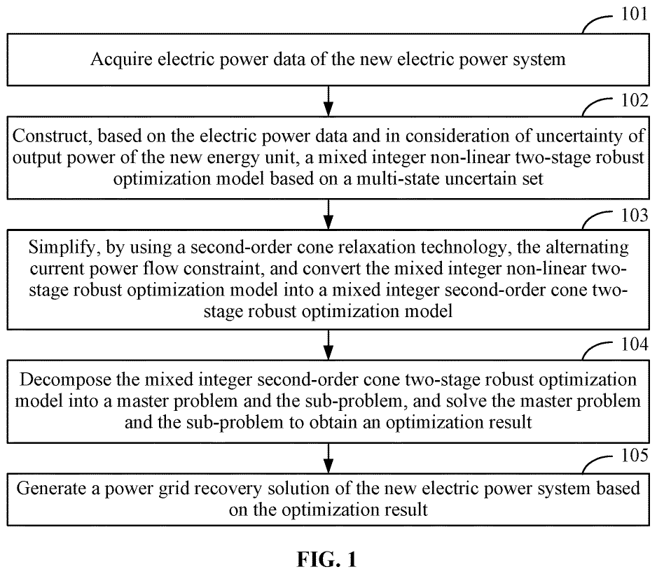

FIG. 1 is a schematic flowchart of a power grid recovery method of a new electric power system based on a second-order cone transformation according to an embodiment of the present application, and the method includes the following steps.

In step 101, electric power data of the new electric power system is acquired.

Firstly, a generator starting sequence, a bus and line charging sequence, and a load recovery sequence predicted in a decision-making power grid are obtained, an output power and an amount of load recovery of a unit including a new energy unit are obtained, and these data are used as electric power data in a first stage of the new electric power system in an expected scenario.

Secondly, an output power of a rescheduling unit and an amount of recovered load of the rescheduling unit are acquired as electric power data in a second stage of the new electric power system in a worst energy fluctuation scenario.

In step 102, a mixed integer non-linear two-stage robust optimization model based on a multi-state uncertain set is constructed based on the electric power data and in consideration of uncertainty of output power of the new energy unit.

The mixed integer non-linear two-stage robust optimization model includes an alternating current power flow constraint.

Exemplarily, the mixed integer non-linear two-stage robust optimization model of the new electric power system is established with the aim of minimizing power outage losses in the expected scenario and minimizing power outage losses and an amount of load adjustment of the system in the worst energy fluctuation scenario. The mixed integer non-linear two-stage robust optimization model includes a first stage objective function and a second stage objective function.

A objective function of the mixed integer non-linear two-stage robust optimization model is represented by:

$${{{min}_{{u}_{i , b}^{s} , {u}_{i , d}^{s} , {u}_{i , g}^{s}}}_{{u}_{ij , l}^{s} , {p}_{i , g}^{s} , {q}_{i , g}^{s}}}_{{p}_{r}^{s}} \{ \begin{matrix}{\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + \\ {max}_{{y}_{i , g}^{s , j}} {{min}_{\hat{{p}_{i , g}^{s}} , \hat{{q}_{i , g}^{s}} , \hat{{p}_{r}^{s}}}}_{\hat{{p}_{i , d}^{s}}} {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ]\end{matrix} \} , \qquad ( 1 )$$

where,

$${{{min}_{{u}_{i , b}^{s} , {u}_{i , d}^{s} , {u}_{i , g}^{s}}}_{{u}_{ij , l}^{s} , {p}_{i , g}^{s} , {q}_{i , g}^{s}}}_{{p}_{r}^{s}} \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] \}$$

represents the first stage objective function;

$${{{min}_{{u}_{i , b}^{s} , {u}_{i , d}^{s} , {u}_{i , g}^{s}}}_{{u}_{ij , l}^{s} , {p}_{i , g}^{s} , {q}_{i , g}^{s}}}_{{p}_{r}^{s}} \{ {max}_{{y}_{i , g}^{s , j}} {{min}_{\hat{{p}_{i , g}^{s}} , \hat{{q}_{i , g}^{s}} , \hat{{p}_{r}^{s}}}}_{\hat{{p}_{i , d}^{s}}} {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] \}$$

represents the second stage objective function; N_{T} represents a number of time periods of a recovery process of the new electric power system, where a time length of each time period is ΔT, total recovery time is N_{S}, and it is assumed that a black start unit and a node where the black start unit is located recover at a time 0;

$${u}_{i , b}^{s}$$

represents a state of an i-th bus node in a time period s, where a value of 1 for

$${u}_{i , b}^{s}$$

represents that the i-th bus node has recovered, and a value of 0 for

$${u}_{i , b}^{s}$$

represents that the i-th bus node has not recovered;

$${u}_{i , d}^{s}$$

represents a state of an i-th load node in the time period s, where a value of 1 for

$${u}_{i , d}^{s}$$

represents that the i-th load node has recovered, and a value of 0 for

$${u}_{i , d}^{s}$$

represents that the i-th load node has not recovered;

$${u}_{i , g}^{s}$$

represents a state of an i-th unit node in the time period s, where a value of 1 for

$${u}_{i , g}^{s}$$

represents the i-th unit node has recovered, and a value of 0 for

$${u}_{i , g}^{s}$$

represents the i-th unit node has not recovered, and the i-th unit node in

$${u}_{i , g}^{s}$$

is directed to all units, including a conventional unit and a new energy unit, when the i-th unit node in

$${u}_{i , g}^{s}$$

is directed to the new energy unit, i=r;

$${u}_{ij , l}^{s}$$

represents whether a line of connection nodes (i, j) is recovered in the time period s, where a value of 1 for

$${u}_{ij , l}^{s}$$

represents that the connection nodes (i, j) has recovered, and a value of 0 for

$${u}_{ij , l}^{s}$$

represents that the connection nodes (i, j) has not recovered;

$${p}_{i , g}^{s}$$

represents an active output power of an i-th conventional unit in the time period s in an expected scenario;

$${q}_{i , g}^{s}$$

represents a reactive output power of the i-th conventional unit in the time period s in the expected scenario;

$${p}_{r}^{s}$$

represents an actual active output power of a r-th new energy unit in the time period s;

$${p}_{i , d}^{s}$$

represents an amount of load recovered by the i-th load node in the time period s; W_{i,d} represents a load weight coefficient of the i-th load node;

$$\hat{{p}_{i , g}^{s}}$$

represents an active output power of the i-th conventional unit in the time period s after an adjustment in a rescheduling stage;

$$\hat{{q}_{i , g}^{s}}$$

represents a reactive output power of the i-th conventional unit in the time period s after the adjustment in the rescheduling stage;

$$\hat{{p}_{r}^{s}}$$

represents an actual active output power of the r-th new energy unit in the time period s after the adjustment in the rescheduling stage;

$$\hat{{p}_{i , d}^{s}}$$

represents an amount of load recovered by the i-th load node in the time period s after the adjustment in the rescheduling stage; N_{BUS} represents a total number of bus nodes; and

$${y}_{i , g}^{s , j}$$

represents an outer layer optimization variable of the second stage objective function.

As described above, in the expected scenario, a magnitude of output power and an amount of recovered load of the unit including the conventional unit and the new energy unit, are each a predicted value.

The mixed integer non-linear two-stage robust optimization model further includes a conventional unit output power characteristic constraint, a new energy unit output power uncertainty constraint based on the multi-state uncertain set, a new energy unit actual output power constraint, a node voltage constraint, a line transmission power constraint, a device recovery state constraint, a line allowed recovery moment constraint, a system frequency constraint and a node power balance constraint.

The conventional unit output power characteristic constraint includes a conventional unit output power constraint before grid connection, a conventional unit output power ramp constraint, a conventional unit output power constraint, a conventional unit cold start time limit constraint and a conventional unit hot start time limit constraint.

The conventional unit output power constraint before grid connection is represented by.

$${p}_{i , g}^{s} = 0 , {q}_{i , g}^{s} = 0 , {\sum }_{j = 0}^{s} Δ T \leq {t}_{1 , i} , ∀ i ∀ s \qquad ( 2 )$$

where,

$${p}_{i , g}^{s}$$

represents an active output power of the i-th conventional unit in the time period s in the expected scenario;

$${q}_{i , g}^{s}$$

represents a reactive output power of the i-th conventional unit in the time period s in the expected scenario, and t_{1,i} represents a moment when the i-th conventional unit starts to perform grid connection. The formula (2) represents that the active output power and the reactive output power of the i-th conventional unit before grid connection are 0.

The conventional unit output power ramp constraint is represented by:

$$0 \leq {p}_{i , g}^{s} - {p}_{i , g}^{s - 1} \leq {u}_{i , g}^{s} {Rm}_{i} Δ T , {t}_{1 , i} \leq {\sum }_{j = 0}^{s} Δ T \leq {t}_{2 , i} , ∀ i ∀ s \qquad ( 3 )$$

$$- {u}_{i , g}^{s} {Rm}_{i} Δ T \leq {p}_{i , g}^{s} - {p}_{i , g}^{s - 1} \leq {u}_{i , g}^{s} {Rm}_{i} Δ T , {\sum }_{j = 0}^{s} Δ T \geq {t}_{2 , i} , ∀ i ∀ s \qquad ( 4 )$$

where, t_{2,i} represents a moment when an output power of the i-th conventional unit reaches a minimum output power; and Rmᵢ represents a ramp rate of a conventional unit i.

$${p}_{i , g}^{s - 1}$$

represents an active output power of the i-th conventional unit in a time period s−1 in the expected scenario, where the time period s−1 is a time period prior to the time period s; j represents a j-th time period, where j=0, 1, . . . , s; the formula (3) represents that active power of the i-th conventional unit needs to satisfy the one-way ramp constraint after the i-th conventional unit is subjected to grid connection and before the i-th conventional unit reaches the minimum output power; and the formula (4) represents upper and lower limit restraints of the active power after the active power of the i-th conventional unit reaches the minimum output power.

The conventional unit output power constraint is represented by:

$${u}_{i , g}^{s} \underline{{p}_{i , g}} \leq {p}_{i , g}^{s} \leq {u}_{i , g}^{s} \overline{{p}_{i , g}} , {\sum }_{j = 0}^{s} Δ T \geq {t}_{2 , i} , ∀ i ∀ s , \qquad ( 5 )$$

$${u}_{i , g}^{s} \underline{{q}_{i , g}} \leq {q}_{i , g}^{s} \leq {u}_{i , g}^{s} \overline{{q}_{i , g}} , {\sum }_{j = 0}^{s} Δ T \geq {t}_{1 , i} , ∀ i ∀ s , \qquad ( 6 )$$

where, p̅_̅{̅i̅,̅g̅}̅ represents an upper limit of an active output power of the i-th conventional unit; p_{i,g} represents a lower limit of the active output power of the i-th conventional unit; q̅_̅{̅i̅,̅g̅}̅ represents an upper limit of a reactive output power of the i-th conventional unit q_{i,g} represents a lower limit of the reactive output power of the i-th conventional unit; the formula (5) represents upper limit and lower limit constraints of reactive power after the i-th conventional unit is subjected to grid connection; and the formula (6) represents a ramp constraint needing to be satisfied after the active power of the i-th conventional unit reaches the minimum output power.

The conventional unit cold/hot starting time limit constraint is represented by:

$$( {Tg}_{i}^{ch} - {Tg}_{i}^{tj} ) \geq ( 1 - {u}_{i , g}^{s} ) {\sum }_{j = 0}^{s} Δ T ∀ i , ∀ s , \qquad ( 7 )$$

$${u}_{i , g}^{s + 1} ( {Tg}_{i}^{cl} - {Tg}_{i}^{tj} ) \leq {u}_{i , g}^{s + 1} {\sum }_{j = 0}^{s} Δ T ∀ i , ∀ s , \qquad ( 8 )$$

where,

$${Tg}_{i}^{tj}$$

represents time that the i-th conventional unit has been shut down before a black start 0 moment,

$${Tg}_{i}^{ch}$$

represents a maximum start time limit of the i-th conventional unit from the shutdown to the restart, if the i-th conventional unit has no limit of a hot start time limit, then

$${Tg}_{i}^{ch}$$

takes a very large number, for example,

$${Tg}_{i}^{ch} = 1000$$

in this embodiment;

$${Tg}_{i}^{cl}$$

is a minimum start time limit of the i-th conventional unit from the shutdown to the restart, if the i-th conventional unit has no limit of cold start time limit, then

$${Tg}_{i}^{cl} = 0 ; {u}_{i , g}^{s + 1}$$

represents a state of the i-th unit node in the time period s+1, a value of 1 for

$${u}_{i , g}^{s + 1}$$

represents that the i-th unit node has been recovered, a value of 0 for

$${u}_{i , g}^{s + 1}$$

represents that the i-th unit node has not been recovered, and the time period s+1 is a time period next to the time period s. The formula (7) represents that an i-th conventional unit to be hot-started should be recovered within the maximum hot start time limit thereof. The cold start unit must be shut down for a minimum

$${Tg}_{i}^{cl}$$

time after the shutdown and then it is able to be restarted, and the formula (8) is its corresponding constraint expression.

The multi-state uncertain set U is constructed with regard to the new energy unit output power uncertainty constraint to describe the new energy unit output power uncertainty. The multi-state uncertain set U of the new energy unit output power uncertainty constraint is represented by:

$$U = \{ \begin{matrix}{\tilde{p}}_{r}^{s} ∈ {R}^{N} : {\tilde{p}}_{r}^{s} = {\sum }_{z = 1}^{N} {y}_{r}^{s , z} {w}_{r}^{s , z} , s = 1 , … , {N}_{T} \\ {\sum }_{z = 1}^{N} {y}_{r}^{s , z} = 1 , {y}_{r}^{s , z} ∈ \{ 0 , 1 \} , s = 1 , … , {N}_{T} \\ {\sum }_{s = 1}^{{N}_{T}} \vert \frac{{\sum }_{z = 1}^{N} z \cdot {y}_{r}^{s , z} - ( N + 1 ) / 2}{( N + 1 ) / 2} \vert \leq {Γ}_{g , p} , ∀ r ∈ {Ω}_{E}\end{matrix} \} ;$$

where,

$${\tilde{p}}_{r}^{s}$$

represents a predicted value of an active output power of a r-th new energy unit in a time period s in an expected scenario;

$${w}_{r}^{s , z}$$

is output power corresponding to a z-th state of the r-th new energy unit in the time period s;

$${y}_{r}^{s , z}$$

is 0 or 1, wherein

$${y}_{r}^{s , z} = 1$$

represents that the output power of the r-th new energy unit is in a state z in the time period s, and

$${y}_{r}^{s , z} = 0$$

represents that the output power of the r-th new energy unit is not in the state z in the time period s; Nis a number of total states; Γ_{g,p} is a budget value of new energy power generation and is a limitation to a fluctuation amount in a recovery period; Ω_{E} is a set of power generation nodes for accessing the new energy unit; and R is a rational number set. The formula (9) represents that power of the r-th new energy unit at the t moment is a linear combination of power values

$${w}_{r}^{s , z}$$

of all states; the formula (10) represents that, within the same moment, the output power of the new energy unit is only in one state, such as a minimum value, a maximum value or an expected value or an average value, and the state can be even more refined, thereby considering more states; and the formula (11) is a generalized budget constraint for limiting fluctuations in the output power of the new energy unit.

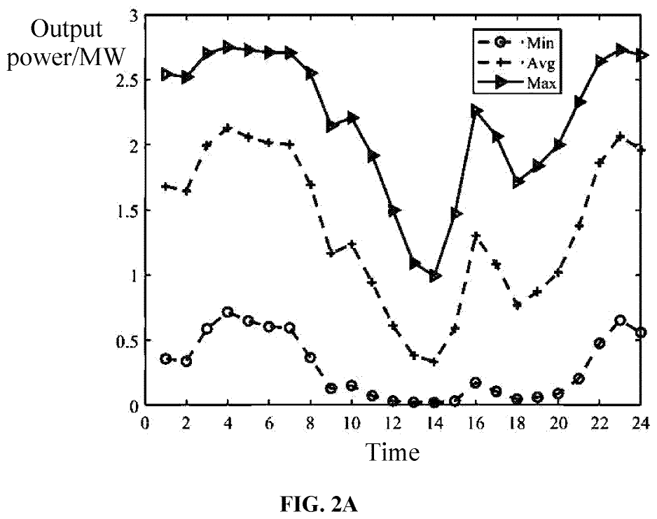

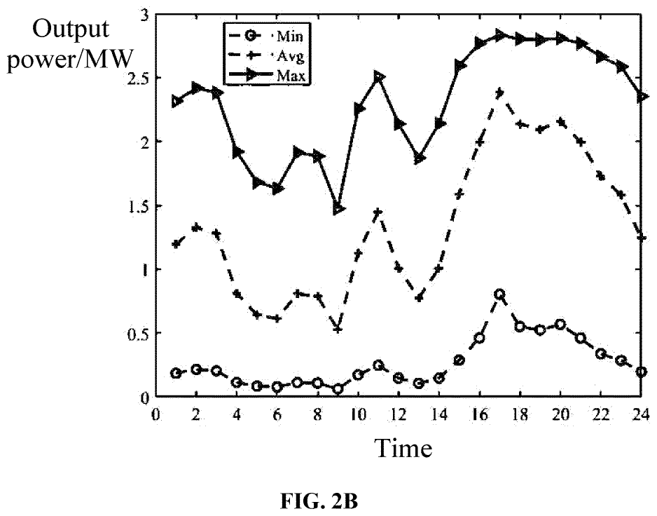

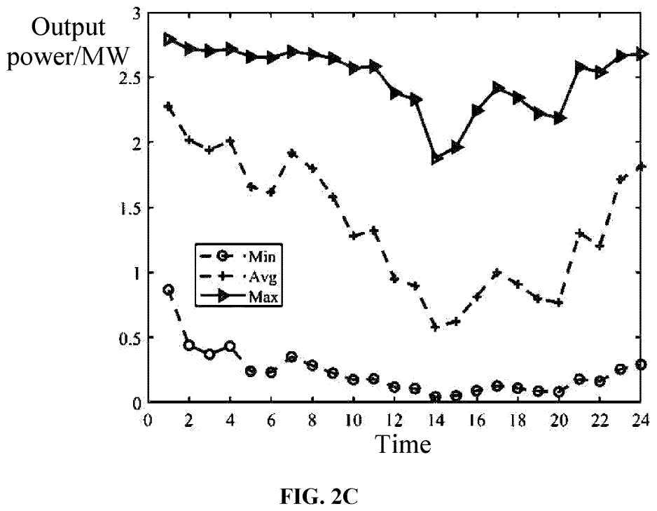

In some embodiments, output power data of three wind power plants within a period of time are selected, where the abscissa is time (hours), and the ordinate is an output power value (megawatt). FIG. 2A is a schematic diagram showing a state of a daily output power value of a first wind power plant, FIG. 2B is a schematic diagram showing a state of a daily output power value of a second wind power plant, and FIG. 2C is a schematic diagram showing a state of a daily output power value of a third wind power plant. A historical statistical analysis and a fractional-order regression approximation technique are performed on an uncertain variable (a magnitude of the wind power output power) to obtain a state value (s=1, 2, 3; t=1, . . . , 24) corresponding to each state thereof. In consideration that the number of output power states of the wind power plant in each time period is 3, which are respectively a maximum value (Max), an average value (Avg) and a minimum value (Min), where curves from top to bottom respectively represent a state value corresponding to the output power of the new energy.

The new energy unit actual output power constraint is represented by:

$$0 \leq {p}_{r}^{s} \leq {u}_{i , g}^{s} {\tilde{p}}_{r}^{s} , ∀ r ∀ s , \qquad ( 12 )$$

where, the formula (12) represents that an actual active power output power of the r-th new energy unit in the time period s does not exceed the predicted value

$${{p}^{▯}}_{r}^{s} .$$

The node voltage constraint is represented by:

$$0 \leq {p}_{r}^{s} \leq {u}_{i , g}^{s} {\tilde{p}}_{r}^{s} , ∀ r ∀ s , \qquad ( 13 )$$

where,

$${V}_{i}^{s}$$

represents a voltage amplitude value of a connection node i in the time period s;

$${V}_{j}^{s}$$

represents a voltage amplitude value of a connection node j in the time period s, Vₘᵢₙ represents a lower limit of amplitude values of all nodes, and Vₘₐₓ represents an upper limit of the amplitude values of all nodes. The formula (13) represents that the voltage of the node should be ensured within the normal operating range.

The line transmission power constraint is represented by:

$$- {p}_{ij , max} {u}_{ij , l}^{s} \leq {p}_{ij}^{s} \leq {p}_{ij , max} {u}_{ij , l}^{s} , ( i , j ) ∈ {Ω}_{L} , ∀ s , \qquad ( 14 )$$

where,

$${p}_{ij}^{s}$$

represents an active power flowing through a line between connection nodes (i, j) in the time period s, p_{ij,max} represents an upper limit of the active power flowing through the line between the connection nodes (i, j), and Ω_{L} represents a set of lines. The formula (14) represents that the power of the line transmission should not exceed its specified maximum power.

The device recovery state constraint is represented by:

$${u}_{i , g}^{s} \leq {u}_{i , b}^{s} ∀ i , ∀ s , \qquad ( 15 )$$

$${u}_{i , d}^{s} \leq {u}_{i , b}^{s} ∀ i , ∀ s , \qquad ( 16 )$$

$$0 \leq {u}_{ij , l}^{s} \leq {u}_{i , b}^{s} + {u}_{j , b}^{s} ( i , j ) ∈ {Ω}_{L} , ∀ s , \qquad ( 17 )$$

$$0 \leq {u}_{ij , l}^{s} \leq {u}_{i , b}^{s} + {u}_{j , b}^{s} ( i , j ) ∈ {Ω}_{L} , ∀ s , \qquad ( 18 )$$

$${u}_{j , b}^{s} + {u}_{ij , l}^{s} \leq 1 + {u}_{i , b}^{s} ( i , j ) ∈ {Ω}_{L} , ∀ s , \qquad ( 19 )$$

$$0 \leq {u}_{i , b}^{s} \leq {\sum }_{( i , j ) ∈ {Ω}_{L}}^{} {u}_{ij , l}^{s} ∀ i , ∀ s , \qquad ( 20 )$$

$${u}_{i , b}^{s} \leq {u}_{i , b}^{s + 1} ∀ i , ∀ s , \qquad ( 21 )$$

$${u}_{ij , l}^{s} \leq {u}_{ij , l}^{s + 1} ( i , j ) ∈ {Ω}_{L} , ∀ s , \qquad ( 22 )$$

$${u}_{i , d}^{s} \leq {u}_{i , d}^{s + 1} ∀ i , ∀ s , \qquad ( 23 )$$

$${u}_{i , g}^{s} \leq {u}_{i , g}^{s + 1} ∀ i , ∀ s . \qquad ( 24 )$$

The formulas (15) and (16) represent that the generator and the load are able to be started only after a bus connected to the generator and a bus connected to the load are energized; the formulas (17) and (18) represent that if a line is recovered in the time period s, at least one bus of buses connected to the line has been recovered in the time period s; the formula (19) represents that when one end node i (or j) of a branch l is recovered in the time period s, if the branch l is recovered in the time period s, then another node j (or i) of the branch l must also be recovered in the time period s, and an end node of the line and the line are recovered simultaneously, to accelerate the recovery process of the subsequent network; the formula (20) represents that if a bus is recovered in the time period s, then at least one line of lines connected to the bus is recovered in the time period s; the formula (21) represents that the bus, once recovered, will not be cut; the formula (22) represents that the line, once recovered, will not be cut; the formula (23) represents that the load, once recovered, will not be cut; and the formula (24) represents that the generator, once recovered, will not be cut.

The line allowed recovery moment constraint is represented by:

$${\sum }_{s = 1}^{N} ( 1 - {u}_{ij , l}^{s} ) \geq ⌈ min ( {N}_{BS - l} ) / k ⌉ ( i , j ) ∈ {Ω}_{L} , ∀ s . \qquad ( 25 )$$

In this embodiment, a maximum number k of recoverable layer allowed for each time period is introduced to prevent the overlong calculation caused by the overlarge corresponding search range due to the overlarge number of the recovery layers. In the formula, N_{BS-1} is a set of the number of nodes included in each feasible path from the black start power supply to a line 1, and ┌⋅┐ represents a ceiling operation.

The system frequency constraint is represented by:

$$Δ P \leq Δ {f}_{max} ( {\sum }_{i = 0}^{{N}_{g}^{s}} {Kg}_{i} + {\sum }_{i = 0}^{{N}_{d}^{s}} {Kl}_{i , d} ) , \qquad ( 26 )$$

where, ΔP is total power required by a to-be-started unit or load input by the unit to be started in a current time period; Kgᵢ and Kl_{i,d} are frequency power effect coefficients of the i-th conventional unit and the load, respectively; Kl_{i,d} takes a value of 1 to 3, and the value of Kl_{i,d} depends on the type of load. The formula (26) represents that the sum (or large load) of the power used by all plants of the unit to be started needs to be less than or equal to a maximum power value of the recovered network available for starting the device under the maximum allowable frequency drop in the current time period.

The node power balance constraint is represented by:

$${u}_{i , g}^{s} {p}_{i , g}^{s} + {u}_{i , g}^{s} {p}_{r}^{s} = {u}_{i , d}^{s} {p}_{i , d}^{s} + {\sum }_{( i , j ) ∈ {Ω}_{L}} {u}_{ij}^{s} {p}_{ij}^{loss , s} , \qquad ( 27 )$$

$${u}_{i , g}^{s} {q}_{i , g}^{s} = {u}_{i , d}^{s} {q}_{i , d}^{s} + {\sum }_{( i , j ) ∈ {Ω}_{L}} {u}_{ij}^{s} {q}_{ij}^{loss , s} . \qquad ( 28 )$$

The formula (27) is a line loss between nodes (i, j) in the time period s for active power of each node, and the formula (28) is a line loss between nodes (i, j) in the time period s for reactive power of each node.

The alternating current power flow constraint is represented by:

$$\{ \begin{matrix}{p}_{ij}^{s} = {u}_{ij , l}^{s} ( {{G}_{ij} ( {V}_{i}^{s} )}^{2} - {V}_{i}^{s} {V}_{j}^{s} ( {G}_{ij} cos {θ}_{ij}^{s} + {B}_{ij} sin {θ}_{ij}^{s} ) ) \\ {q}_{ij}^{s} = {u}_{ij , l}^{s} ( - {{B}_{ij} ( {V}_{i}^{s} )}^{2} - {V}_{i}^{s} {V}_{j}^{s} ( {G}_{ij} sin {θ}_{ij}^{s} + {B}_{ij} cos {θ}_{ij}^{s} ) ) \\ {p}_{ji}^{s} = {u}_{ij , l}^{s} ( {{G}_{ij} ( {V}_{j}^{s} )}^{2} - {V}_{i}^{s} {V}_{j}^{s} ( {G}_{ij} cos {θ}_{ij}^{s} + {B}_{ij} sin {θ}_{ij}^{s} ) ) \\ {q}_{ji}^{s} = {u}_{ij , l}^{s} ( - {{B}_{ij} ( {V}_{j}^{s} )}^{2} - {V}_{i}^{s} {V}_{j}^{s} ( {G}_{ij} sin {θ}_{ij}^{s} + {B}_{ij} cos {θ}_{ij}^{s} ) ) \\ {p}_{ij}^{loss , s} = {p}_{ij}^{s} + {p}_{ij}^{s} , ∀ i , ∀ s \\ {q}_{ij}^{loss , s} = {q}_{ij}^{s} + {q}_{ij}^{s} , ∀ i , ∀ s\end{matrix} , \qquad ( 29 )$$

where, Gᵢⱼ represents a conductance value of the line between the connection nodes (i, j); Bᵢⱼ represents a susceptance value of the line between the connection nodes (i, j);

$${p}_{ij}^{s}$$

represents an active power flowing through the line between the connection nodes (i, j) in the time period s;

$${q}_{ij}^{s}$$

represents a reactive ower flowing through the line between the connection nodes (i, j) in the time period s;

$${p}_{ji}^{s}$$

represents an active power flowing through a line between connection nodes (j, i) in the time period s,

$${q}_{ji}^{s}$$

represents a reactive power flowing through the line between the connection nodes (j, i) in the time period s;

$${p}_{ij}^{loss , s}$$

represents a loss of the active power of the line between the connection nodes (i, j) in the time period s;

$${q}_{ij}^{loss , s}$$

represents a loss of the reactive power of the line between the connection nodes (i, j) in the time period s;

$${u}_{ij , l}^{s}$$

represents a state of the line between the connection nodes (i, j) in the time period s, where a value of 1 for

$${u}_{ij , l}^{s}$$

represents that the connection nodes (i, j) has recovered, and a value of 0 for

$${u}_{ij , l}^{s}$$

represents that the connection nodes (i, j) has not recovered;

$${V}_{i}^{s}$$

represents a voltage amplitude of the connection node i in the time period s;

$${V}_{j}^{s}$$

represents a voltage amplitude of a connection node j in the time period s; and

$${θ}_{ij}^{s}$$

represents a phase angle of

$${V}_{i}^{s} and {V}_{j}^{s} .$$

In step 103, the alternating current power flow constraint is simplified by using a second-order cone relaxation technology, and the mixed integer non-linear two-stage robust optimization model is converted into a mixed integer second-order cone two-stage robust optimization model.

Simplifying the alternating current power flow constraint by using the second-order cone relaxation technology includes: performing a variable replacement on a voltage phase angle cross term of the alternating current power flow constraint of a two-stage robust optimization model recovered by the system to obtain an alternating current power flow constraint after the variable replacement.

$${V}_{i}^{s} {V}_{j}^{s} cos {θ}_{ij}^{s} = {r}_{ij}^{s} , \qquad ( 30 )$$

$${V}_{i}^{s} {V}_{j}^{s} sin {θ}_{ij}^{s} = {t}_{ij}^{s} , \qquad ( 31 )$$

$${( {V}_{i}^{s} )}^{2} = {u}_{i - j , i}^{s} , \qquad ( 32 )$$

$${( {V}_{j}^{s} )}^{2} = {u}_{i - j , j}^{s} , \qquad ( 32 )$$

where, the voltage phase angle cross terms are denoted by

$${r}_{ij}^{s} and {t}_{ij}^{s} ,$$

and the voltage square terms are denoted by

$${u}_{i - j , i}^{s} and {u}_{i - j , j}^{s} ;$$

and adding a second-order cone relaxation constraint to the alternating current power flow constraint after the variable replacement to obtain a simplified alternating current power flow constraint.

The second-order cone relaxation constraint is represented by:

$${( {r}_{ij}^{s} )}^{2} + {( {t}_{ij}^{s} )}^{2} \leq {u}_{i - j , i}^{s} {u}_{i - j , j}^{s} . \qquad ( 33 )$$

The simplified alternating current power flow constraint is represented by:

$$\{ \begin{matrix}{p}_{i j}^{s} = \sqrt{2} {G}_{ij} {u}_{i - j , i}^{s} - {G}_{ij} {r}_{i j}^{s} - {B}_{ij} {t}_{i j}^{s} \\ {p}_{j i}^{s} = \sqrt{2} {G}_{ij} {u}_{i - j , j}^{s} - {G}_{ij} {r}_{i j}^{s} + {B}_{ij} {t}_{i j}^{s} \\ {q}_{i j}^{s} = - \sqrt{2} {B}_{ij} {u}_{i - j , i}^{s} + {B}_{ij} {r}_{i j}^{s} - {G}_{ij} {t}_{i j}^{s} \\ {q}_{j i}^{s} = - \sqrt{2} {B}_{ij} {u}_{i - j , j}^{s} + {B}_{ij} {r}_{i j}^{s} + {G}_{ij} {t}_{i j}^{s} \\ {p}_{i j}^{l o s s , s} = {p}_{i j}^{s} + {p}_{ji}^{s} , ∀ i , ∀ s \\ {q}_{i j}^{l o s s , s} = {q}_{i j}^{s} + {q}_{ji}^{s} , ∀ i , ∀ s\end{matrix} , \qquad ( 34 )$$

where,

$${V}_{i}^{s} {V}_{j}^{s} cos {θ}_{ij}^{s} = {r}_{ij}^{s} , {V}_{i}^{s} , {V}_{j}^{s} sin {θ}_{ij}^{s} = {t}_{ij}^{s} , {V}_{i}^{s}$$

represents a voltage amplitude of a connection node i in a time period s;

$${V}_{j}^{s}$$

represents a voltage amplitude of a connection node j in the time period s;

$${θ}_{ij}^{s}$$

represents a phase angle of

$${V}_{i}^{s} and {V}_{j}^{s} ; {u}_{i - j , i}^{s}$$

represents a square of

$${V}_{i}^{s} ; {u}_{i - j , j}^{s}$$

represents a square of

$${V}_{j}^{s} ;$$

Gᵢⱼ represents a conductance value of a line between connection nodes (i, j); Bᵢⱼ represents a susceptance value of the line between the connection nodes (i, j);

$${p}_{ij}^{s}$$

represents an active power flowing through the line between the connection nodes (i, j) in the time period s;

$${q}_{ij}^{s}$$

represents a reactive power flowing through the line between the connection nodes (i, j) in the time period s;

$${p}_{ji}^{s}$$

represents an active power flowing through a line between connection nodes (j, i) in the time period s;

$${q}_{ji}^{s}$$

represents a reactive power flowing through the line between the connection nodes (j, i) in the time period s;

$${p}_{ij}^{loss , s}$$

represents a loss of the active power of the line between the connection nodes (i, j) in the time period s, and

$${q}_{ij}^{loss , s}$$

represents a loss of the reactive power of the line between the connection nodes (i, j) in the time period s.

In the second-order cone relaxation technology, the second-order cone relaxation needs to be tightened by using a directional objective function, so that the relaxation amount is reduced as much as possible, and thus a corresponding power flow constraint is satisfied, thereby ensuring the correctness of the solution. The objective function constructed in this embodiment satisfies the requirement of the second-order cone relaxation technology.

In step 104, the mixed integer second-order cone two-stage robust optimization model is decomposed into a master problem and the sub-problem, and the master problem and the sub-problem are solved to obtain an optimization result.

An objective function ƒ_{MP} of the master problem is represented by:

$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} , \qquad ( 35 )$$

where, α is an auxiliary variable.

The sub-problem minimizes an amount of load loss and an amount of load adjustment in a worst scenario in a case of giving the solution to the master problem. The outer layer optimization variable is an uncertain parameter

$${y}_{i , g}^{s , j}$$

and an outer layer problem seeks the worst scenario, i. e., maximizes the amount of load loss and the amount of load adjustment. The inner layer optimization variables are rescheduling variables

$$( \hat{{p}_{i , g}^{s}} , \hat{{q}_{i , g}^{s}} , \hat{{p}_{r}^{s}} , \hat{{p}_{i , d}^{s}} ) ,$$

and the inner layer problem is that after the value of the optimization variable of the outer layer is given (namely, after the new energy output power state is given), the load loss is reduced by rescheduling. An objective function ƒ_{SP} of the sub-problem is represented by:

$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] , \qquad ( 36 )$$

A constraint condition of the master problem includes:

$$s . t : \{ \begin{matrix}α \geq {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] \\ \tilde{{p}_{r}^{s}} = \tilde{{w}_{i , g}^{s}} \\ ( 2 ) - ( 8 ) , ( 12 ) - ( 28 ) , ( 33 ) - ( 34 )\end{matrix} , \qquad ( 37 )$$

where, the constraint condition of the master problem still follow the conventional unit output power characteristic constraint, the new energy unit output power uncertainty constraint, the new energy unit actual output power constraint, the node voltage constraint, the line transmission power constraint, the device recovery state constraint, the line allowed recovery moment constraint, the system frequency constraint and the node power balance constraint. The formula (37) includes formulas (2) to (8), formulas (12) to (28), and formulas (33) to (34).

$$α \geq {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ]$$

represents a secant plane generated by solving the sub-problem, and

$$\tilde{{p}_{r}^{s}} = \tilde{{w}_{i , g}^{s}}$$

represents that the output power prediction value of the r-th new energy unit in the master problem is the expected value.

In some embodiments, before the master problem (MP) and the sub-problem (SP) are solved iteratively, a lower limit of iteration is set as LB=0 and an upper limit of iteration is set as UB=+∞, the initial number of times for iterations is k=1, and the auxiliary variable is α=0.

In some embodiments, solving the master problem and the sub-problem to obtain the optimization result includes: eliminating, by using a solving acceleration strategy, a line transmission power constraint and a unit output power ramp constraint of the mixed integer second-order cone two-stage robust optimization model, and solving a master problem without the line transmission power constraint and the unit output power ramp constraint to obtain a solving result, where in the master problem, a to-be-recovered amount of load by each node is fixed, and an optimal solution of integer variables in the expected scenario is obtained, the optimal solution includes a load node recovery sequence, a unit start/stop sequence, a bus and line charging sequence, and a magnitude of an output power value of the conventional unit in the expected scenario, and the solving result is transmitted to the sub-problem; comparing the solving result described above with the line transmission power constraint and the unit output power ramp constraint to check for a problematic conventional unit that violates the line transmission power constraint or the unit output power ramp constraint, where in some embodiments, if the magnitude of the output power of the conventional unit in the above-described solving result is not within the range of the line transmission power constraint or the unit output power ramp constraint, then it indicates that a unit corresponding to the magnitude of the output power of the conventional unit violates the line transmission power constraint or the unit output power ramp constraint; and for the problematic conventional unit, adding the transmission power constraint and the unit output power ramp constraint to a constraint of the sub-problem to form an added constraint, and solving, based on the added constraint, the master problem and the sub-problem to obtain the optimization result.

In some embodiments, solving, based on the added constraint, the master problem and the sub-problem to obtain the optimization result includes: solving, based on the added constraint, the master problem to obtain an optimal solution X of the master problem and a first objective function value

$${f}_{MP}^{*}$$

corresponding to the master problem; updating, based on the first objective function value, a lower limit of iteration

$$LB = max \{ LB , {f}_{MP}^{*} \}$$

of the mixed integer second-order cone two-stage robust optimization mode; solving, based on the optimal solution x′ of the master problem, the sub-problem to obtain an optimal solution

$${y}_{s}^{*}$$

of the sub-problem, a second objective function value

$${f}_{SP}^{*}$$

corresponding to the sub-problem, and a worst energy fluctuation scenario set

$$\{ {y}_{i , g}^{s , *} \} ,$$

where the worst energy fluctuation scenario set includes an expected output power value

$$\tilde{{p}_{r}^{s}}$$

of each new energy unit in each time period; and updating, based on the second objective function value

$${f}_{SP}^{*} ,$$

an upper limit of iteration

$$UB = min \{ UB , {f}_{SP}^{*} \}$$

of the mixed integer second-order cone two-stage robust optimization mode, where an iteration is performed based on a ratio |UB−LB|/|LB|≤ε of a difference value between an updated iteration lower limit and an updated iteration upper limit to the updated iteration lower limit, if then the ratio is greater than a preset threshold value ε, i. e., |UB−LB|/|LB|>ε, then the second objective function value and the worst energy fluctuation scenario set are updated, the added constraint is updated based on an updated second objective function value and an updated worst energy fluctuation scenario set, the master problem is solved according to an updated added constraint and then based on the added constraint to continue the iterative solution, and the iteration is stopped until the ratio is less than or equal to the preset threshold value ε, i. e., |UB−LB|/|LB|≤ε to obtain the optimization result.

The added constraint of the sub-problem includes:

$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s , \qquad ( 38 )$$

$$0 \leq \hat{{p}_{r}^{s}} \leq {\tilde{p}}_{r}^{s} , \qquad ( 39 )$$

$$\{ \begin{matrix}0 \leq \hat{{p}_{i , d}^{s}} \leq {p}_{i , d}^{s} \\ 0 \leq \hat{{q}_{i , d}^{s}} \leq \overline{{q}_{i , d}^{s}}\end{matrix} , \qquad ( 40 )$$

$$\underline{{q}_{i , g}^{s}} \leq \hat{{q}_{i , g}^{s}} \leq \overline{{q}_{i , g}^{s}} , \qquad ( 41 )$$

formulas (9) to (28) and formulas (33) to (34). Where, Rmᵢ represents a ramp rate of an i-th conventional unit;

$$\overline{{p}_{i , g}^{s}}$$

represents an active output power upper limit of the i-th conventional unit in a time period s;

$$\underline{{p}_{i , g}^{s}}$$

represents an active output power lower limit of the i-th conventional unit in the time period s;

$$\overline{{q}_{i , g}^{s}}$$

represents a reactive output power upper limit of the i-th conventional unit in the time period s;

$$\underline{{q}_{i , g}^{s}}$$

represents a reactive output power lower limit of the i-th conventional unit in the time period s;

$${q}_{i , d}^{s}$$

represents a reactive power of an i-th load node in the time period s;

$$\hat{{q}_{i , d}^{s}}$$

represents a reactive power of the i-th load node in the time period s after an adjustment in a rescheduling stage;

$$\overline{{q}_{i , d}^{s}}$$

represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;

$${u}_{i , b}^{s}$$

represents a state of an i-th bus node in the time period s, wherein a value of 1 for

$${u}_{i , b}^{s}$$

represent that the i-th bus node has recovered, and a value of 0 for

$${u}_{i , b}^{s}$$

represents that the i-th bus node has not recovered;

$${u}_{i , d}^{s}$$

represents a state of the i-th load node in the time period s, wherein a value of 1 for

$${u}_{i , d}^{s}$$

represents that the i-th load node has recovered, and a value of 0 for

$${u}_{i , d}^{s}$$

represents that the i-th load node has not recovered;

$${u}_{i , g}^{s}$$

represents a state of an i-th unit node in the time period s, wherein a value of 1 for

$${u}_{i , g}^{s}$$

represents that the i-th unit node has recovered, and a value of 0 for

$${u}_{i , g}^{s}$$

represents that the i-th unit node has not recovered;

$${u}_{ij , l}^{s}$$

represents whether a line of connection nodes (i, j) is recovered in the time period s, wherein a value of 1 for

$${u}_{ij , l}^{s}$$

represents that the connection node (i, j) has recovered, and a value of 0 for

$${u}_{ij , l}^{s}$$

represents that the connection node (i, j) has not recovered;

$${p}_{i , g}^{s}$$

represents an active output power of the i-th conventional unit in the time period s in an expected scenario;

$${q}_{i , g}^{s}$$

represents a reactive output power of the i-th conventional unit in the time period s in the expected scenario;

$${p}_{r}^{s}$$

represents an actual active output power of a r-th new energy unit in the time period s;

$${\tilde{p}}_{r}^{s}$$

represents a predicted value of an active output power of the r-th new energy unit in the time period s in the expected scenario;

$${p}_{i , d}^{s}$$

is an amount of load in the expected scenario, that is, a predicted value of load amount recovered by i-th load node in time period s; W_{i,d} represents a load weight coefficient of the i-th load node;

$$\hat{{p}_{i , g}^{s}}$$

represents an active output power of the i-th conventional unit in the time period s after the adjustment in the rescheduling stage;

$$\hat{{q}_{i , g}^{s}}$$

represents a reactive output power of the i-th conventional unit in the time period s after the adjustment in the rescheduling stage;

$$\hat{{p}_{r}^{s}}$$

represents an actual active output power of the r-th new energy unit in the time period s after the adjustment in the rescheduling stage;

$$\hat{{p}_{i , d}^{s}}$$

represents an amount of load recovered by the i-th load node in the time period s after the adjustment in the rescheduling stage; N_{BUS} represents a total number of bus nodes; and

$${y}_{i , g}^{s , j}$$

is an outer layer optimization variable of the second stage objective function.

In step 105, a power grid recovery solution of the new electric power system is generated based on the optimization result.

In some embodiments, the load node recovery sequence, the unit start/stop sequence, the bus and line charging sequence, and the magnitude of the output power value of the conventional unit in the expected scenario are solved, and the power grid recovery solution of the new electric power system is formed based on these contents.

In an embodiment of the present application, in order to verify the effectiveness of the method of the present application, Table 1 provides arithmetic example basic parameters of the method of the present application, and the arithmetic example basic parameters include a maximum number of recovery layers, a maximum frequency offset, an upper limit of a node voltage, a lower limit of the node voltage, an upper limit of a phase angle difference, a total recovery time period, a recovery time period interval and an iteration deviation.

TABLE 1
arithmetic example basic parameters

| Parameter | Symbol | Numerical value |
|---|---|---|
| Maximum number of | k | 2 |
| recovery layers | | |
| Maximum frequency | Δfₘₐₓ | 0.5 HZ |
| offset | | |
| Load weight | w | 0.8~1 |
| Upper limit of node | Vₘₐₓ | 1.1 |
| voltage | | |
| Lower limit of node | Vₘᵢₙ | 0.9 |
| voltage | | |
| Upper limit of phase angle difference | ${θ}_{ij , max}^{s}$ | 90° |
| Total recovery time | N_{T} | 8 |
| period | | |
| Recovery time period | ΔT | 20 min |
| interval | | |
| Iterative deviation | ε | 0.001 |

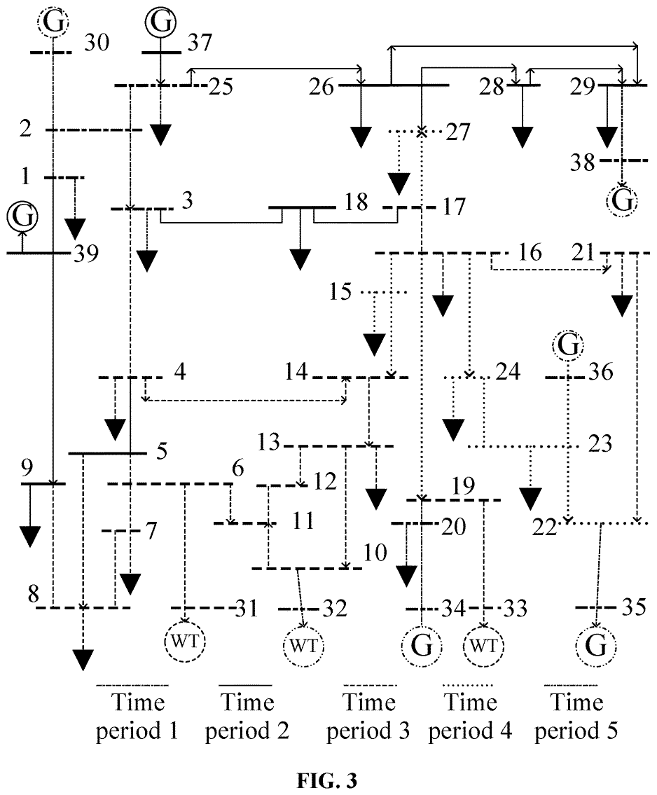

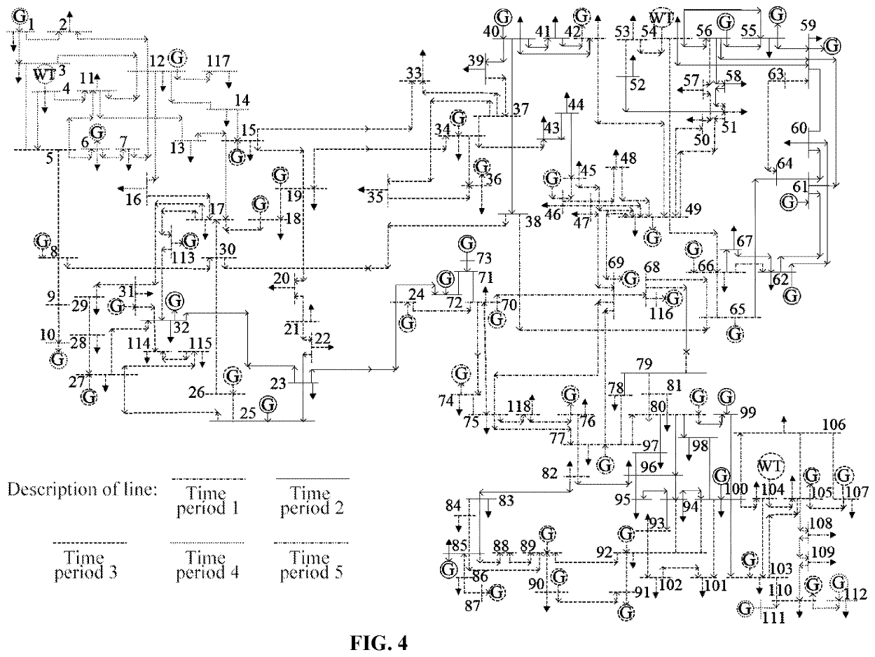

In this embodiment, recovery conditions of an IEEE39 node system and an IEEE118 node system are obtained, as shown in FIGS. 3 and 4 (in FIGS. 3 and 4, G represents a thermal power unit, and WT represents a wind power unit), and Table 2 shows power outage losses and network losses during recovery. In a unit recovery stage, the introduction of new energy may accelerate the starting of the coal-fired unit, so that the total recovery time of the unit is the shortest and thus the recovery cost of the unit is reduced. In the power grid and load recovery stage, new energy is simultaneously input on the basis of a large number of started units, so that the net frame and load recovery can be accelerated, the system recovery time can be significantly reduced overall, and thus the economic losses are greatly reduced.

In this embodiment, a voltage phase angle cross term replacement error and a second-order cone relaxation error are used to solve an error for a low non-linearization and second-order cone transformation technology to analyze the error.

The calculation formula of the voltage phase angle cross term replacement error is represented by:

$${E}_{1} = \vert {V}_{i}^{s} {V}_{j}^{s} cos {θ}_{ij}^{s} - {r}_{ij}^{s} \vert , \qquad ( 42 )$$

$${E}_{2} = \vert {V}_{i}^{s} {V}_{j}^{s} sin {θ}_{ij}^{s} - {t}_{ij}^{s} \vert , \qquad ( 43 )$$

The calculation formula of the second-order cone relaxation error is represented by:

$${ε}_{3} = \vert ( {r}_{ij}^{s} ) + {( {t}_{ij}^{s} )}^{2} - {u}_{i - j , i}^{s} {u}_{i - j , j}^{s} \vert , \qquad ( 44 )$$

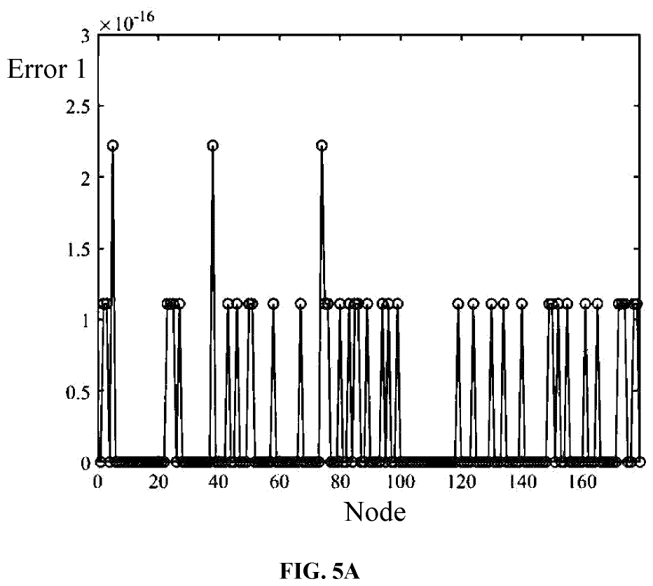

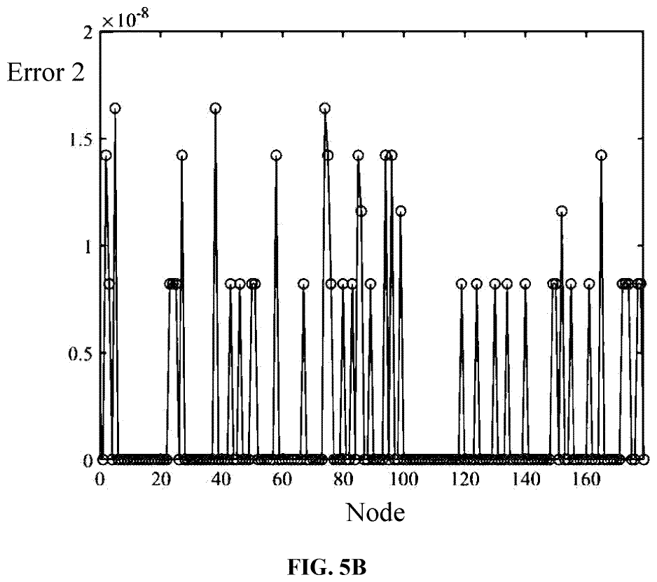

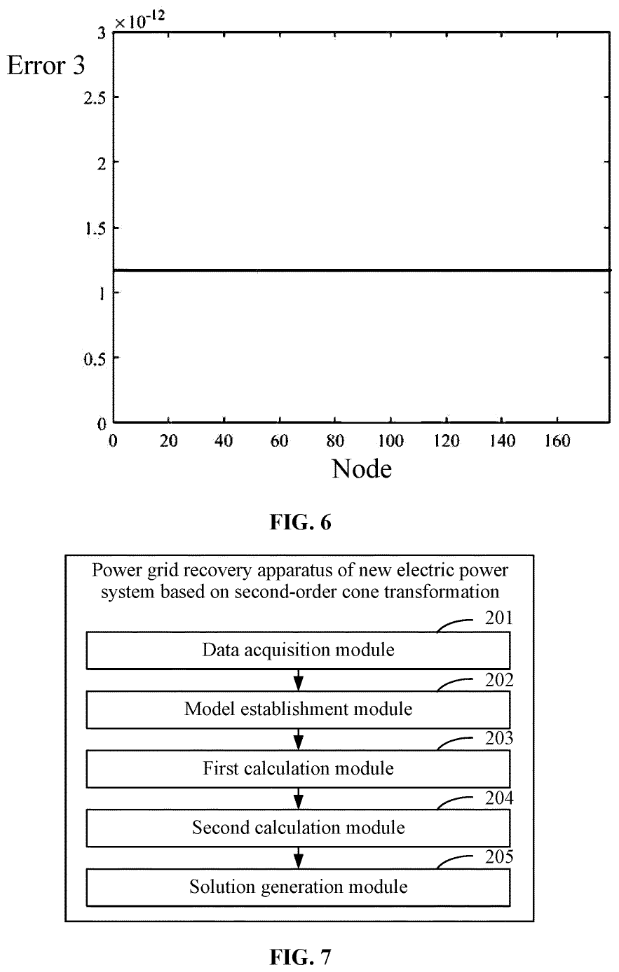

FIG. 5A and FIG. 5B show low non-linearization errors of all branches by using the IEEE118 node system as a research object, where the abscissa Node represents the Node, and the ordinate error represents the error. FIG. 5A represents low non-linearization errors of all branches with order of magnitude of 10⁻¹⁶, and FIG. 5B represents low non-linearization errors of all branches with order of magnitude of 10⁻⁸. It can be found that errors after the replacement of the voltage and phase angle variable are less than the order of magnitude of 10⁻¹⁶ and the order of magnitude of 10⁻⁸, respectively, to ensure that the node voltage amplitude and the branch phase angle difference accuracy satisfy the actual engineering requirements. FIG. 6 provides a relaxation error between a voltage and a phase angle. It can be found that the relaxation error is less than an order of magnitude of 10⁻¹², this is because that although the second-order cone relaxation expands the feasible region, the objective function is a minimization problem, and the solving result is a lower limit in the feasible region; therefore, the solution of the model after the second-order cone relaxation is the same as the solution of an original model, and the accuracy thereof is able to satisfy the requirements in practical applications.

TABLE 2
optimization result of method of the present application
under IEEE39 node system and IEEE118 node system

| | IEEE39 | IEEE118 |
|---|---|---|
| Index | node system | node system |
| Power failure | 49.9 | 293.91 |
| loss/Megawatt (MW) | | |
| Network loss/MW | 2.91 | 122.26 |
| Solution time/second (S) | 24.81 | 528.18 |

According to the power grid recovery method of the new electric power system based on the second-order cone transformation provided in the embodiments of the present application, the mixed integer non-linear two-stage robust optimization model based on the multi-state uncertain set is constructed, the second-order cone relaxation technology is adopted to process the alternating current power flow constraint of the model to convert the mixed integer non-linear model into a mixed integer second-order cone model, and finally, the line transmission power constraint and the unit output power ramp constraint of the mixed integer second-order cone two-stage robust optimization model is eliminated, so that the time required for generating the power grid recovery solution of the new electric power system is shortened. Then a two-stage distributed robust model is decomposed into the master problem and the sub-problem, the solution is implemented by alternately iterating the master problem and the sub-problem, so that the solution accuracy of the model is ensured, the system recovery emergency plan satisfying an actual power grid operation requirement can be generated in the shortest time, politics and economic losses caused by the large-scale power failure are reduced, and thus the better engineering promotion value is obtained.

Sizes of sequence numbers of the multiple steps in the above-described embodiments do not imply an execution sequence, and an execution sequence of each process should be determined according to the function and the internal logic of the process, which should not constitute any limitation to the implementation process of the embodiment of the present application.

The following is an apparatus embodiment of the present application. For details not described herein, reference may be made to the corresponding method embodiment.

FIG. 7 is a schematic structural diagram of a power grid recovery apparatus of an electric power system based on a second-order cone transformation according to an embodiment of the present application. For ease of description, only parts related to the embodiment of the present application are illustrated as follows.

As shown in FIG. 7, the power grid recovery apparatus 200 of the electric power system based on the second-order cone transformation includes a data acquisition module 201, a model establishment module 202, a first calculation module 203, a second calculation module 204 and a solution generation module 205. The data acquisition module 201 is configured to acquire electric power data of a new electric power system. The model establishment module 202 is configured to construct, based on the electric power data and in consideration of uncertainty of output power of a new energy unit, a mixed integer non-linear two-stage robust optimization model based on a multi-state uncertain set of the new electric power system, where the mixed integer non-linear two-stage robust optimization model includes an alternating current power flow constraint. The first calculation module 203 is configured to simplify the alternating current power flow constraint by using a second-order cone relaxation technology, and convert the mixed integer non-linear two-stage robust optimization model into a mixed integer second-order cone two-stage robust optimization model. The second calculation module 204 is configured to decompose the mixed integer second-order cone two-stage robust optimization model into a master problem and a sub-problem, and solve the master problem and the sub-problem to obtain an optimization result. The solution generation module 205 is configured to generate a power grid recovery solution of the new electric power system based on the optimization result.

The beneficial effects of the power grid recovery apparatus of the electric power system based on the second-order cone transformation provided in the embodiments of the present application may refer to the beneficial effects of the power grid recovery method of the electric power system based on the second-order cone transformation.

In a possible implementation, in the model establishment module 202, the mixed integer non-linear two-stage robust optimization model includes a first stage objective function and a second stage objective function.

An objective function of the mixed integer non-linear two-stage robust optimization model is represented by:

$${{{min}_{{u}_{i , b}^{s} , {u}_{i , d}^{s} , {u}_{i , g}^{s}}}_{{u}_{ij , l}^{s} , {p}_{i , g}^{s} , {q}_{i , g}^{s}}}_{{p}_{r}^{s}} \{ \begin{matrix}{\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + \\ {max}_{{y}_{i , g}^{s , j}} {{min}_{\hat{{p}_{i , g}^{s}} , \hat{{q}_{i , g}^{s}} , \hat{{p}_{r}^{s}}}}_{\hat{{p}_{i , d}^{s}}} {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ]\end{matrix} \} \qquad ( 1 )$$

where,

$${{{min}_{{u}_{i , b}^{s} , {u}_{i , d}^{s} , {u}_{i , g}^{s}}}_{{u}_{ij , l}^{s} , {p}_{i , g}^{s} , {q}_{i , g}^{s}}}_{{p}_{r}^{s}} \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] \}$$

represents the first stage objective function;

$${{{min}_{{u}_{i , b}^{s} , {u}_{i , d}^{s} , {u}_{i , g}^{s}}}_{{u}_{ij , l}^{s} , {p}_{i , g}^{s} , {q}_{i , g}^{s}}}_{{p}_{r}^{s}} \{ {max}_{{y}_{i , g}^{s , j}} {{min}_{\hat{{p}_{i , g}^{s}} , \hat{{q}_{i , g}^{s}} , \hat{{p}_{r}^{s}}}}_{\hat{{p}_{i , d}^{s}}} {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] \}$$

represents the second stage objective function; N_{T} represents a number of time periods of a recovery process of the new electric power system, wherein a time length of each time period is ΔT, total recovery time is N_{S} and it is assumed that a black start unit and a node where the black start unit is located recover at a time 0;

$${u}_{i , b}^{s}$$

represents a state of an i-th bus node in a time period s, wherein a value of 1 for

$${u}_{i , b}^{s}$$

represents that the i-th bus node has recovered, and a value of 0 for

$${u}_{i , b}^{s}$$

represents that the i-th bus node has not recovered;

$${u}_{i , d}^{s}$$

represents a state of an i-th load node in the time period s, wherein a value of 1 for

$${u}_{i , d}^{s}$$

represents that the i-th load node has recovered, and a value of 0 for

$${u}_{i , d}^{s}$$

represents that the i-th load node has not recovered;

$${u}_{i , g}^{s}$$

represents a state of an i-th unit node in the time period s, wherein a value of 1 for

$${u}_{i , g}^{s}$$

represents the i-th unit node has recovered, and a value of 0 for

$${u}_{i , g}^{s}$$

represents the i-th unit node has not recovered;

$${u}_{ij , l}^{s}$$

represents whether a line of connection nodes (i, j) is recovered in the time period s, wherein a value of 1 for

$${u}_{ij , l}^{s}$$

represents that the connection nodes (i, j) has recovered, and a value of 0 for

$${u}_{ij , l}^{s}$$

represents that the connection nodes (i, j) has not recovered;

$${p}_{i , g}^{s}$$

represents an active output power of an i-th conventional unit in the time period s in an expected scenario;

$${q}_{i , g}^{s}$$

represents a reactive output power of the i-th conventional unit in the time period s in the expected scenario;

$${p}_{r}^{s}$$

represents an actual active output power of a r-th new energy unit in the time period s;

$${p}_{i , d}^{s}$$

represents an amount of load recovered by the i-th load node in the time period s; W_{i,d} represents a load weight coefficient of the i-th load node;

$$\hat{{p}_{i , g}^{s}}$$

represents an active output power of the i-th conventional unit in the time period s after an adjustment in a rescheduling stage;

$$\hat{{q}_{i , g}^{s}}$$

represents a reactive output power of the i-th conventional unit in the time period s after the adjustment in the rescheduling stage;

$$\hat{{p}_{r}^{s}}$$

represents an actual active output power of the r-th new energy unit in the time period s after the adjustment in the rescheduling stage;

$$\hat{{p}_{i , d}^{s}}$$

represents an amount of load recovered by the i-th load node in the time period s after the adjustment in the rescheduling stage; N_{BUS} represents a total number of bus nodes; and

$${y}_{i , g}^{s , j}$$

represents an outer layer optimization variable of the second stage objective function.

In a possible implementation, in the model establishment module 202, the mixed integer non-linear two-stage robust optimization model further includes a conventional unit output power characteristic constraint, a new energy unit output power uncertainty constraint, a new energy unit actual output power constraint, a node voltage constraint, a line transmission power constraint, a device recovery state constraint, a line allowed recovery moment constraint, a system frequency constraint and a node power balance constraint. The unit output power characteristic constraint includes a conventional unit output power constraint before grid connection, a conventional unit output power ramp constraint, a conventional unit output power constraint, and a conventional unit cold/hot starting time limit constraint.

The multi-state uncertain set U of the new energy unit output power uncertainty constraint is represented by:

$$U = \{ \begin{matrix}{\tilde{p}}_{r}^{s} ∈ {R}^{N} : {\tilde{p}}_{r}^{s} = {\sum }_{z = 1}^{N} {y}_{r}^{s , z} {w}_{r}^{s , z} , s = 1 , … , {N}_{T} \\ {\sum }_{z = 1}^{N} {y}_{r}^{s , z} = 1 , {y}_{r}^{s , z} ∈ \{ 0 , 1 \} , s = 1 , … , {N}_{T} \\ {\sum }_{s = 1}^{{N}_{T}} \vert \frac{{\sum }_{z = 1}^{N} z \cdot {y}_{r}^{s , z} - ( N + 1 ) / 2}{( N + 1 ) / 2} \vert \leq {Γ}_{g , p} , ∀ r ∈ {Ω}_{E}\end{matrix} \}$$

where,

$${\tilde{p}}_{r}^{s}$$

represents a predicted value of an active output power of a r-th new energy unit in a time period s in an expected scenario;

$${w}_{r}^{s , z}$$

is output power corresponding to a z-th state of the r-th new energy unit in the time period s;

$${y}_{r}^{s , z}$$

is 0 or 1, wherein

$${y}_{r}^{s , z} = 1$$

represents that the output power of the r-th new energy unit is in a state z in the time period s, and

$${y}_{r}^{s , z} = 0$$

represents that the output power of the r-th new energy unit is not in the state z in the time period s; Nis a number of total states; Γ_{g,p} is a budget value of new energy power generation and is a limitation to a fluctuation amount in a recovery period; Ω_{E} is a set of power generation nodes for accessing the new energy unit; R is a rational number set; and N_{T} represents a number of time periods of a recovery process of the new electric power system.

The new energy unit actual output power constraint is represented by:

$$0 \leq {p}_{r}^{s} \leq {u}_{i , g}^{s} {\tilde{p}}_{r}^{s} , ∀ r ∀ s \qquad ( 12 )$$

where,

$${p}_{r}^{s}$$

represents an actual output power value of the r-th new energy unit in the time period s; and

$${u}_{i , g}^{s}$$

represents a state of an i-th unit node in the time period s, wherein a value of 1 for

$${u}_{i , g}^{s}$$

represents that the i-th unit node has been recovered, and a value of 0 for

$${u}_{i , g}^{s}$$

represents that the i-th unit node has not been recovered.

In a possible implementation, in the model establishment module 202, the alternating current power flow constraint is represented by:

$$\{ \begin{matrix}{p}_{i j}^{s} = {u}_{i j , l}^{s} ( {{G}_{i j} ( {V}_{i}^{s} )}^{2} - {V}_{i}^{s} {V}_{j}^{s} ( {G}_{i j} cos {θ}_{i j}^{s} + {B}_{i j} sin {θ}_{i j}^{s} ) ) \\ {q}_{i j}^{s} = {u}_{ij , l}^{s} ( - {{B}_{i j} ( {V}_{i}^{s} )}^{2} + {V}_{i}^{s} {V}_{j}^{s} ( {G}_{i j} sin {θ}_{i j}^{s} - {B}_{i j} cos {θ}_{i j}^{s} ) ) \\ {p}_{j i}^{s} = {u}_{ij , l}^{s} ( {{G}_{i j} ( {V}_{j}^{s} )}^{2} - {V}_{i}^{s} {V}_{j}^{s} ( {G}_{i j} cos {θ}_{i j}^{s} - {B}_{i j} sin {θ}_{i j}^{s} ) ) \\ {q}_{j i}^{s} = {u}_{ij , l}^{s} ( - {{B}_{i j} ( {V}_{j}^{s} )}^{2} + {V}_{i}^{s} {V}_{j}^{s} ( {G}_{i j} sin {θ}_{i j}^{s} + {B}_{i j} cos {θ}_{i j}^{s} ) ) \\ {p}_{i j}^{l o s s , s} = {p}_{i j}^{s} + {p}_{j i}^{s} , ∀ i , ∀ s \\ {q}_{i j}^{l o s s , s} = {q}_{i j}^{s} + {q}_{j i}^{s} , ∀ i , ∀ s\end{matrix} \qquad ( 29 )$$

where, Gᵢⱼ represents a conductance value of a line between connection nodes (i, j); Bᵢⱼ represents a susceptance value of the line between the connection nodes (i, j);

$${p}_{ij}^{s}$$

represents an active power flowing through the line between the connection nodes (i, j) in a time period s;

$${q}_{ij}^{s}$$

represents a reactive power flowing through the line between the connection nodes (i, j) in the time period s;

$${p}_{ji}^{s}$$

represents an active power flowing through a line between connection nodes (j, i) in the time period s,

$${q}_{ji}^{s}$$

represents a reactive power flowing through the line between the connection nodes (j, i) in the time period s;

$${p}_{ij}^{l o s s , s}$$

represents a loss of the active power of the line between the connection nodes (i, j) in the time period s;

$${q}_{ij}^{loss , s}$$

represents a loss of the reactive power of the line between the connection nodes (i, j) in the time period s;

$${u}_{ij , l}^{s}$$

represents a state of the line between the connection nodes (i, j) in the time period s, wherein a value of 1 for

$${u}_{ij , l}^{s}$$

represents that the connection nodes (i, j) has recovered, and a value of 0 for

$${u}_{ij , l}^{s}$$

represents that the connection nodes (i, j) has not recovered;

$${V}_{i}^{s}$$

represents a voltage amplitude of a connection node i in the time period s;

$${V}_{j}^{s}$$

represents a voltage amplitude of a connection node j in the time period s; and

$${θ}_{ij}^{s}$$

represents a phase angle of

$${V}_{i}^{s} and {V}_{j}^{s} .$$

In a possible implementation, in the first calculation module 203, that the alternating current power flow constraint is simplified by using the second-order cone relaxation technology includes that: a variable replacement is performed on a voltage phase angle cross term of the alternating current power flow constraint of a two-stage robust optimization model recovered by the system to obtain an alternating current power flow constraint after the variable replacement; and a second-order cone relaxation constraint is added to the alternating current power flow constraint after the variable replacement to obtain a simplified alternating current power flow constraint.

In a possible implementation, in the first calculation module 203, the simplified alternating current power flow constraint is represented by:

$$\{ \begin{matrix}{p}_{ij}^{s} = \sqrt{2} {G}_{ij} {u}_{i - j , i}^{s} - {G}_{ij} {r}_{ij}^{s} - {B}_{ij} {t}_{ij}^{s} \\ {p}_{ji}^{s} = \sqrt{2} {G}_{ij} {u}_{i - j , j}^{s} - {G}_{ij} {r}_{ij}^{s} + {B}_{ij} {t}_{ij}^{s} \\ {q}_{ij}^{s} = - \sqrt{2} {B}_{ij} {u}_{i - j , i}^{s} + {B}_{ij} {r}_{ij}^{s} - {G}_{ij} {t}_{ij}^{s} \\ {q}_{ji}^{s} = - \sqrt{2} {B}_{ij} {u}_{i - j , j}^{s} + {B}_{ij} {r}_{ij}^{s} + {G}_{ij} {t}_{ij}^{s} \\ {p}_{ij}^{loss , s} = {p}_{ij}^{s} + {p}_{ji}^{s} , ∀ i , ∀ s \\ {q}_{ij}^{loss , s} = {q}_{ij}^{s} + {q}_{ji}^{s} , ∀ i , ∀ s\end{matrix} \qquad ( 34 )$$

where,

$${V}_{i}^{s} {V}_{j}^{s} cos {θ}_{ij}^{s} = {r}_{ij}^{s} , {V}_{i}^{s} {V}_{j}^{s} sin {θ}_{ij}^{s} = {t}_{ij}^{s} , {V}_{i}^{s}$$

represents a voltage amplitude of a connection node i in a time period s;

$${V}_{j}^{s}$$

represents a voltage amplitude of a connection node j in the time period s;

$${θ}_{ij}^{s}$$

represents a phase angle of

$${V}_{i}^{s} and {V}_{j}^{s} ; {u}_{i - j , i}^{s}$$

represents a square of

$${V}_{i}^{s} ; {u}_{i - j , j}^{s}$$

represents a square of

$${V}_{j}^{s} ;$$

Gᵢⱼ represents a conductance value of a line between connection nodes (i, j); Bᵢⱼ represents a susceptance value of the line between the connection nodes (i, j);

$${p}_{ij}^{s}$$

represents an active power flowing through the line between the connection nodes (i, j) in the time period s;

$${q}_{ij}^{s}$$

represents a reactive power flowing through the line between the connection nodes (i, j) in the time period s;

$${p}_{ji}^{s}$$

represents an active power flowing through a line between connection nodes (j, i) in the time period s;

$${q}_{ji}^{s}$$

represents a reactive power flowing through the line between the connection nodes (j, i) in the time period s;

$${p}_{ij}^{loss , s}$$

represents a loss of the active power of the line between the connection nodes (i, j) in the time period s, and

$${q}_{ij}^{loss , s}$$

represents a loss of the reactive power of the line between the connection nodes (i, j) in the time period s.

In a possible implementation, in the second calculation module 204, that the master problem and the sub-problem are solved to obtain the optimization result includes that: a line transmission power constraint and a unit output power ramp constraint of the mixed integer second-order cone two-stage robust optimization model are eliminated by using a solving acceleration strategy, a master problem without the line transmission power constraint and the unit output power ramp constraint is solved to obtain a solving result, and the solving result is transmitted to the sub-problem; the solving result is compared with the line transmission power constraint and the unit output power ramp constraint to check for a problematic conventional unit that violates the line transmission power constraint or the unit output power ramp constraint; and for the problematic conventional unit, the transmission power constraint and the unit output power ramp constraint are added to a constraint of the sub-problem to form an added constraint, and the master problem and the sub-problem are solved based on the added constraint to obtain the optimization result.

In a possible implementation, in the second calculation module 204, that the master problem and the sub-problem are solved based on the added constraint to obtain the optimization result includes that: the master problem is solved based on the added constraint to obtain an optimal solution of the master problem and a first objective function value corresponding to the master problem; an iteration lower limit of the mixed integer second-order cone two-stage robust optimization model is updated based on the first objective function value; the sub-problem is solved based on the optimal solution of the master problem to obtain an optimal solution of the sub-problem, a second objective function value corresponding to the sub-problem, and a worst energy fluctuation scenario set; an iteration upper limit of the mixed integer second-order cone two-stage robust optimization model is updated based on the second objective function value; a ratio of a difference value between an updated iteration lower limit and an updated iteration upper limit to the updated iteration lower limit is calculated, the second objective function value and the worst energy fluctuation scenario set are updated in response to the ratio greater than a preset threshold value; the added constraint is updated based on an updated second objective function value and an updated worst energy fluctuation scenario set; and the step of solving, based on the added constraint, the master problem is transferred to according to an updated added constraint to continue the iterative solution, and the iteration is stopped until the ratio is less than or equal to the preset threshold value to obtain the optimization result.

In a possible implementation, in the second calculation module 204, the objective function ƒ_{MP} of the master problem is represented by:

$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} . \qquad ( 35 )$$

The objective function ƒ_{SP} of the sub-problem is represented by:

$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} \\ + {\sum }_{i = 1}^{{N}_{BUS}} ( {p}_{i , d}^{s} - \hat{{p}_{i , d}^{s} )}\end{matrix} ] . \qquad ( 36 )$$

The added constraint of the sub-problem includes:

$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s , \qquad ( 38 )$$

$$0 \leq \hat{{p}_{r}^{s}} \leq {\tilde{p}}_{r}^{s} , \qquad ( 39 )$$

$$\{ \begin{matrix}0 \leq \hat{{p}_{i , d}^{s}} \leq {p}_{i , d}^{s} \\ 0 \leq \hat{{q}_{i , d}^{s}} \leq \overline{{q}_{i , d}^{s}}\end{matrix} , \qquad ( 40 )$$

$${q}_{i , g}^{s} \leq \hat{{q}_{i , g}^{s}} \leq \overline{{q}_{i , g}^{s}} , \qquad ( 41 )$$

where, α is an auxiliary variable; Rmᵢ represents a ramp rate of an i-th conventional unit;

$$\overline{{p}_{i , g}^{s}}$$

represents an active output power upper limit of the i-th conventional unit in a time period s;

$$\underline{{p}_{i , g}^{s}}$$

represents an active output power lower limit of the i-th conventional unit in the time period s;

$$\overline{{q}_{i , g}^{s}}$$

represents a reactive output power upper limit of the i-th conventional unit in the time period s;

$$\underline{{q}_{i , g}^{s}}$$

represents a reactive output power lower limit of the i-th conventional unit in the time period s;

$${q}_{i , d}^{s}$$

represents a reactive power of an i-th load node in the time period s;

$$\hat{{q}_{i , d}^{s}}$$

represents a reactive power of the i-th load node in the time period s after an adjustment in a rescheduling stage;

$$\overline{{q}_{i , d}^{s}}$$

represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;

$${u}_{i , b}^{s} ,$$

represents a state of an i-th bus node in the time period s, wherein a value of 1 for

$${u}_{i , b}^{s} ,$$

represents that the i-th bus node has recovered, and a value of 0 for

$${u}_{i , b}^{s} ,$$

represents that the i-th bus node has not recovered;

$${u}_{i , d}^{s} ,$$

represents a state of the i-th load node in the time period s, wherein a value of 1 for

$${u}_{i , d}^{s} ,$$

represents that the i-th load node has recovered, and a value of 0 for

$${u}_{i , d}^{s}$$

represents that the i-th load node has not recovered;

$${u}_{i , g}^{s}$$

represents a state of an i-th unit node in the time period s, wherein a value of 1 for

$${u}_{i , g}^{s}$$

represents that the i-th unit node has recovered, and a value of 0 for

$${u}_{i , g}^{s}$$

represents that the i-th unit node has not recovered;

$${u}_{ij , l}^{s}$$

represents whether a line of connection nodes (i, j) is recovered in the time period s, wherein a value of 1 for

$${u}_{ij , l}^{s}$$

represents that the connection nodes (i, j) has recovered, and a value of 0 for

$${u}_{ij , l}^{s}$$

represents that the connection nodes (i, j) has not recovered;

$${p}_{i , g}^{s}$$

represents an active output power of the i-th conventional unit in the time period s in an expected scenario;

$${q}_{i , g}^{s}$$

represents a reactive output power of the i-th conventional unit in the time period s in the expected scenario;

$${p}_{r}^{s}$$

represents an actual active output power of a r-th new energy unit in the time period s;

$${\tilde{p}}_{r}^{s}$$

represents a predicted value of an active output power of the r-th new energy unit in the time period s in the expected scenario; represents an amount of load recovered by the i-th load node in the time period s; W_{i,d} represents a load weight coefficient of the i-th load node;

$$\hat{{p}_{i , g}^{s}}$$

represents an active output power of the i-th conventional unit in the time period s after the adjustment in the rescheduling stage;

$$\hat{{q}_{i , g}^{s}}$$

represents a reactive output power of the i-th conventional unit in the time period s after the adjustment in the rescheduling stage;

$$\hat{{p}_{r}^{s}}$$

represents an actual active output power of the r-th new energy unit in the time period s after the adjustment in the rescheduling stage;

$$\hat{{p}_{i , d}^{s}}$$

represents an amount of load recovered by the i-th load node in the time period s after the adjustment in the rescheduling stage; N_{BUS} represents a total number of bus nodes; and

$${y}_{i , g}^{s , j}$$

is an outer layer optimization variable of the second stage objective function.

In some embodiments, an embodiment of the present application provides a power grid recovery method and apparatus of a new electric power system based on a second-order cone transformation, in consideration of the uncertainty of the output power of the new energy unit, the mixed integer non-linear two-stage robust optimization model based on the multi-state uncertain set is constructed, the second-order cone relaxation technology is adopted to process the alternating current power flow constraint of the model to convert the mixed integer non-linear model into the mixed integer second-order cone model, and finally, the two-stage distributed robust model is decomposed into the master problem and the sub-problem, the solution is implemented by alternately iterating the master problem and the sub-problem, so that the solution accuracy of the model is ensured, politics and economic losses caused by the large-scale power failure are reduced, and thus the better engineering promotion value is obtained.

In the above-described embodiments, the description of each embodiment has its own emphasis, and for the parts which are not described in one embodiment, reference may be made to the relevant description of other embodiments.

Those of ordinary skill in the art may be aware that templates, units, and algorithm steps in combination with the examples described in the embodiments disclosed herein may be implemented by an electronic hardware, or a combination of a computer software and the electronic hardware. Whether the functions are executed by hardware or software depends on specific applications and design constraint conditions of the technical solutions. Those skilled in the art may use different methods to implement the described functions for each specific application, but the implementation shall not be considered as going beyond the scope of the present application.

When the module/unit is implemented in the form of a software function unit and is sold or used as an independent product, the module/unit may be stored in one computer-readable storage medium. Based on such an understanding, all or part of the procedures of the methods in the above-described embodiments may be implemented in the present application and may also be implemented by instructing a relevant hardware through a computer program. The computer program may be stored in a computer-readable storage medium, and the computer program, when executed by a processor, may implement the steps of the embodiments of the power grid recovery method of the new electric power system based on the second-order cone transformation described above. The computer program includes a computer program code, and the computer program code may be in a source code form, an object code form, an executable file, or some intermediate forms, and the like. The computer-readable medium may include any entity or apparatus capable of carrying the computer program code, a record medium, a USB disk, a removable hard disk, a magnetic disk, an optical disk, a computer memory, a read-only memory, a random access memory, an electrical carrier signal, a telecommunications signal, a software distribution medium, and the like.

1. A power grid recovery method of a new electric power system based on a second-order cone transformation, comprising:
acquiring electric power data of the new electric power system;
constructing, based on the electric power data and in consideration of uncertainty of output power of a new energy unit, a mixed integer non-linear two-stage robust optimization model based on a multi-state uncertain set of the new electric power system, wherein the mixed integer non-linear two-stage robust optimization model comprises an alternating current power flow constraint;
simplifying, by using a second-order cone relaxation technology, the alternating current power flow constraint, and converting the mixed integer non-linear two-stage robust optimization model into a mixed integer second-order cone two-stage robust optimization model;
decomposing the mixed integer second-order cone two-stage robust optimization model into a master problem and a sub-problem, and solving the master problem and the sub-problem to obtain an optimization result; and
generating a power grid recovery solution of the new electric power system based on the optimization result.

2. The power grid recovery method of a new electric power system based on a second-order cone transformation of claim 1, wherein the mixed integer non-linear two-stage robust optimization model comprises a first stage objective function and a second stage objective function;
a objective function of the mixed integer non-linear two-stage robust optimization model is represented by:
$${min}_{{{u}_{i , b}^{s} , {u}_{i , d}^{s} , {u}_{i , g}^{s}}_{{{u}_{ij , l}^{s}}_{{p}_{r}^{s}} , {p}_{i , g}^{s} , {q}_{i , g}^{s}}} \{ \begin{matrix}{\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + \\ {max}_{{y}_{i , g}^{s , j}} {min}_{{\hat{{p}_{i , g}^{s}}}_{\hat{{p}_{i , d}^{s}}} , \hat{{q}_{i , g}^{s}} , \hat{{p}_{r}^{s}}} {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ]\end{matrix} \} ;$$
wherein
represents the first stage objective function;
$${min}_{{{u}_{i , b}^{s} , {u}_{i , d}^{s} , {u}_{i , g}^{s}}_{{{u}_{ij , l}^{s}}_{{p}_{r}^{s}} , {p}_{i , g}^{s} , {q}_{i , g}^{s}}} \{ {max}_{{y}_{i , g}^{s , j}} {min}_{{\hat{{p}_{i , g}^{s}}}_{\hat{{p}_{i , d}^{s}}} , \hat{{q}_{i , g}^{s}} , \hat{{p}_{r}^{s}}} {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] \}$$
represents the second stage objective function; N_{T} represents a number of time periods of a recovery process of the new electric power system, wherein a time length of each time period is ΔT, total recovery time is N_{S}, and it is assumed that a black start unit and a node where the black start unit is located recover at a time 0;
$${u}_{i , b}^{s}$$
represents a state of an i-th bus node in a time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of an i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents the i-th unit node has recovered, and a value of 0 for
$${u}_{i , g}^{s}$$
represents the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of an i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${p}_{i , d}^{s}$$
represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after an adjustment in a rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
represents an outer layer optimization variable of the second stage objective function.

3. The power grid recovery method of a new electric power system based on a second-order cone transformation of claim 1, wherein the mixed integer non-linear two-stage robust optimization model further comprises a conventional unit output power characteristic constraint, a new energy unit output power uncertainty constraint, a new energy unit actual output power constraint, a node voltage constraint, a line transmission power constraint, a device recovery state constraint, a line allowed recovery moment constraint, a system frequency constraint and a node power balance constraint; wherein the conventional unit output power characteristic constraint comprises a conventional unit output power constraint before grid connection, a conventional unit output power ramp constraint, a conventional unit output power constraint, a conventional unit cold start time limit constraint and a conventional unit hot start time limit constraint;
a multi-state uncertain set U of the new energy unit output power uncertainty constraint is represented by:
$$U = \{ \begin{matrix}{\tilde{p}}_{r}^{s} ∈ {R}^{N} : {\tilde{p}}_{r}^{s} = {\sum }_{z = 1}^{N} {y}_{r}^{s , z} {w}_{r}^{s , z} , s = 1 , … , {N}_{T} \\ {{\sum }_{z = 1}}^{N} {y}_{r}^{s , z} = 1 , {y}_{r}^{s , z} ∈ \{ 0 , 1 \} , s = 1 , … , {N}_{T} \\ {{\sum }_{s = 1}}^{{N}_{T}} \vert \frac{{\sum }_{z = 1}^{N} z \cdot {y}_{r}^{s , z} - ( N + 1 ) / 2}{( N - 1 ) / 2} \vert \leq {Γ}_{g , p} , ∀ r ∈ {Ω}_{E}\end{matrix} \} ;$$
wherein,
$${\tilde{p}}_{r}^{s}$$
represents a predicted value of an active output power of a r-th new energy unit in a time period s in an expected scenario;
$${w}_{r}^{s , z}$$
is output power corresponding to a z-th state of the r-th new energy unit in the time period s;
$${y}_{r}^{s , z}$$
is 0 or 1, wherein
$${w}_{r}^{s , z} = 1$$
represents that the output power of the r-th new energy unit is in a state z in the time period s, and
$${y}_{r}^{s , z} = 0$$
represents that the output power of the r-th new energy unit is not in the state z in the time period s; N is a number of total states; Γ_{g,p} is a budget value of new energy power generation and is a limitation to a fluctuation amount in a recovery period; Ω_{E} is a set of power generation nodes for accessing the new energy unit; R is a rational number set; and N_{T} represents a number of time periods of a recovery process of the new electric power system; and the new energy unit actual output power constraint is represented by:
$$0 \leq {p}_{r}^{s} \leq {u}_{i , g}^{s} {\tilde{p}}_{r}^{s} , ∀ r ∀ s ;$$
wherein,
$${p}_{r}^{s}$$
represents an actual output power value of the r-th new energy unit in the time period s; and
$${u}_{i , g}^{s}$$
represents a state of an i-th unit node in the time period s, wherein a value of 1 for
$${u}_{i , g}^{s}$$
represents that the i-th unit node has been recovered, and a value of 0 for
$${u}_{i , g}^{s}$$
represents that the i-th unit node has not been recovered.

4. The power grid recovery method of a new electric power system based on a second-order cone transformation of claim 1, wherein the alternating current power flow constraint is represented by:
$$\{ \begin{matrix}{p}_{ij}^{s} = {u}_{ij , l}^{s} ( {{G}_{ij} ( {V}_{i}^{s} )}^{2} - {V}_{i}^{s} {V}_{j}^{s} ( {G}_{ij} cos {θ}_{ij}^{s} + {B}_{ij} sin {θ}_{ij}^{s} ) ) \\ {q}_{ij}^{s} = {u}_{ij , l}^{s} ( - {{B}_{ij} ( {V}_{i}^{s} )}^{2} + {V}_{i}^{s} {V}_{j}^{s} ( {G}_{ij} sin {θ}_{ij}^{s} - {B}_{ij} cos {θ}_{ij}^{s} ) ) \\ {p}_{ji}^{s} = {u}_{ij , l}^{s} ( {{G}_{ij} ( {V}_{j}^{s} )}^{2} - {V}_{i}^{s} {V}_{j}^{s} ( {G}_{ij} cos {θ}_{ij}^{s} - {B}_{ij} sin {θ}_{ij}^{s} ) ) \\ {q}_{ji}^{s} = {u}_{ij , l}^{s} ( - {{B}_{ij} ( {V}_{j}^{s} )}^{2} + {V}_{i}^{s} {V}_{j}^{s} ( {G}_{ij} sin {θ}_{ij}^{s} + {B}_{ij} cos {θ}_{ij}^{s} ) ) \\ {p}_{ij}^{loss , s} = {p}_{ij}^{s} + {p}_{ji}^{s} , ∀ i , ∀ s \\ {q}_{ij}^{loss , s} = {q}_{ij}^{s} + {q}_{ji}^{s} , ∀ i , ∀ s\end{matrix} ;$$
wherein, Gᵢⱼ represents a conductance value of a line between connection nodes (i, j); Bᵢⱼ represents a susceptance value of the line between the connection nodes (i, j);
$${p}_{ij}^{s}$$
represents an active power flowing through the line between the connection nodes (i, j) in a time period s;
$${q}_{ij}^{s}$$
represents a reactive power flowing through the line between the connection nodes (i, j) in the time period s;
$${p}_{ji}^{s}$$
represents an active power flowing through a line between connection nodes (j, i) in the time period s,
$${q}_{ji}^{s}$$
represents a reactive power flowing through the line between the connection nodes (j, i) in the time period s;
$${p}_{ij}^{loss , s}$$
represents a loss of the active power of the line between the connection nodes (i, j) in the time period s;
$${q}_{ij}^{loss , s}$$
represents a loss of the reactive power of the line between the connection nodes (i, j) in the time period s;
$${u}_{ij , l}^{s}$$
represents a state of the line between the connection nodes (i, j) in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${V}_{i}^{s}$$
represents a voltage amplitude of a connection node i in the time period s;
$${V}_{j}^{s}$$
represents a voltage amplitude of a connection node j in the time period s; and
$${θ}_{ij}^{s}$$
represents a phase angle of
$${V}_{i}^{s} and {V}_{j}^{s} .$$

5. The power grid recovery method of a new electric power system based on a second-order cone transformation of claim 1, wherein simplifying, by using the second-order cone relaxation technology, the alternating current power flow constraint comprises:
performing a variable replacement on a voltage phase angle cross term of the alternating current power flow constraint of a two-stage robust optimization model recovered by the new electric power system to obtain an alternating current power flow constraint after the variable replacement; and
adding a second-order cone relaxation constraint to the alternating current power flow constraint after the variable replacement to obtain a simplified alternating current power flow constraint.

6. The power grid recovery method of a new electric power system based on a second-order cone transformation of claim 5, wherein the simplified alternating current power flow constraint is represented by:
$$\{ \begin{matrix}{p}_{ij}^{s} = \sqrt{2} {G}_{ij} {u}_{i - j , i}^{s} - {G}_{ij} {r}_{ij}^{s} - {B}_{ij} {t}_{ij}^{s} \\ {p}_{ji}^{s} = \sqrt{2} {G}_{ij} {u}_{i - j , j}^{s} - {G}_{ij} {r}_{ij}^{s} - {B}_{ij} {t}_{ij}^{s} \\ {q}_{ij}^{s} = - \sqrt{2} {B}_{ij} {u}_{i - j , i}^{s} + {B}_{ij} {r}_{ij}^{s} - {G}_{ij} {t}_{ij}^{s} \\ {q}_{ji}^{s} = - \sqrt{2} {B}_{ij} {u}_{i - j , j}^{s} + {B}_{ij} {r}_{ij}^{s} + {G}_{ij} {t}_{ij}^{s} \\ {p}_{ij}^{loss , s} = {p}_{ij}^{s} + {p}_{ji}^{s} , ∀ i , ∀ s \\ {q}_{ij}^{loss , s} = {q}_{ij}^{s} + {q}_{ji}^{s} , ∀ i , ∀ s\end{matrix} ,$$
wherein,
$${V}_{i}^{s} {V}_{j}^{s} cos {θ}_{ij}^{s} = {r}_{ij}^{s} , {V}_{i}^{s} {V}_{j}^{s} sin {θ}_{ij}^{s} = {t}_{ij}^{s} , {V}_{i}^{s}$$
represents a voltage amplitude of a connection node i in a time period s;
$${V}_{j}^{s}$$
represents a voltage amplitude of a connection node j in the time period;
$${θ}_{ij}^{s}$$
represents a phase angle of
$${V}_{i}^{s} and {V}_{j}^{s} ; {u}_{i - j , i}^{s}$$
represents a square of
$${V}_{i}^{s} ; {u}_{i - j , j}^{s}$$
represents a square of
$${V}_{j}^{s} ;$$
Gᵢⱼ represents a conductance value of a line between connection nodes (i, j); Bᵢⱼ represents a susceptance value of the line between the connection nodes (i, j);
$${p}_{y}^{s}$$
represents an active power flowing through the line between the connection nodes (i, j) in the time period s;
$${q}_{y}^{s}$$
represents a reactive power flowing through the line between the connection nodes (i, j) in the time period s;
$${p}_{ji}^{s}$$
represents an active power flowing through a line between connection nodes (j, i) in the time period s;
$${q}_{ji}^{s}$$
represents a reactive power flowing through the line between the connection nodes (j, i) in the time period s;
$${p}_{ij}^{loss , s}$$
represents a loss of the active power of the line between the connection nodes (i, j) in the time period s, and
$${q}_{ij}^{loss , s}$$
represents a loss of the reactive power of the line between the connection nodes (i, j) in the time period s.

7. The power grid recovery method of a new electric power system based on a second-order cone transformation of claim 1, wherein solving the master problem and the sub-problem to obtain the optimization result comprises:
eliminating, by using a solving acceleration strategy, a line transmission power constraint and a unit output power ramp constraint of the mixed integer second-order cone two-stage robust optimization model, solving a master problem without the line transmission power constraint and the unit output power ramp constraint to obtain a solving result, and transmitting the solving result to the sub-problem;
comparing the solving result with the line transmission power constraint and the unit output power ramp constraint to check for a problematic conventional unit that violates the line transmission power constraint or the unit output power ramp constraint; and
for the problematic conventional unit, adding the line transmission power constraint and the unit output power ramp constraint to a constraint of the sub-problem to form an added constraint, and solving, based on the added constraint, the master problem and the sub-problem to obtain the optimization result.

8. The power grid recovery method of a new electric power system based on a second-order cone transformation of claim 7, wherein solving, based on the added constraint, the master problem and the sub-problem to obtain the optimization result comprises:
solving, based on the added constraint, the master problem to obtain an optimal solution of the master problem and a first objective function value corresponding to the master problem;
updating, based on the first objective function value, an iteration lower limit of the mixed integer second-order cone two-stage robust optimization model;
solving, based on the optimal solution of the master problem, the sub-problem to obtain an optimal solution of the sub-problem, a second objective function value corresponding to the sub-problem, and a worst energy fluctuation scenario set;
updating, based on the second objective function value, an iteration upper limit of the mixed integer second-order cone two-stage robust optimization model;
calculating a ratio of a difference value between an updated iteration lower limit and an updated iteration upper limit to the updated iteration lower limit, and updating, in response to the ratio being greater than a preset threshold value, the second objective function value and the worst energy fluctuation scenario set;
updating the added constraint based on an updated second objective function value and an updated worst energy fluctuation scenario set; and
transferring, according to an updated added constraint, to the step of solving, based on the added constraint, the master problem to continue an iterative solution, and stopping the iteration until the ratio is less than or equal to the preset threshold value to obtain the optimization result.

9. The power grid recovery method of a new electric power system based on a second-order cone transformation of claim 1, wherein an objective function ƒ_{MP} of the master problem is represented by:
$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] ;$$
the added constraint of the sub-problem comprises:
$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s ;$$
$$0 \leq \hat{{p}_{r}^{s}} \leq {\tilde{p}}_{r}^{s} ;$$
$$\{ \begin{matrix}0 \leq \hat{{p}_{i , d}^{s}} \leq {p}_{i , d}^{s} \\ 0 \leq \hat{{q}_{i , g}^{s}} \leq \overline{{q}_{i , g}^{s}}\end{matrix} ;$$
$$\underline{{q}_{i , g}^{s}} \leq \hat{{q}_{i , g}^{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.

10. A power grid recovery apparatus of an electric power system based on a second-order cone transformation, comprising
a memory and a processor, wherein the memory stores a program which, when read and executed by the processor, causes the processor to perform the following operations:
acquiring electric power data of a new electric power system;
constructing, based on the electric power data and in consideration of uncertainty of output power of a new energy unit, a mixed integer non-linear two-stage robust optimization model based on a multi-state uncertain set of the new electric power system, wherein the mixed integer non-linear two-stage robust optimization model comprises an alternating current power flow constraint;
simplifying, by using a second-order cone relaxation technology, the alternating current power flow constraint, and converting the mixed integer non-linear two-stage robust optimization model into a mixed integer second-order cone two-stage robust optimization model;
decomposing the mixed integer second-order cone two-stage robust optimization model into a master problem and a sub-problem, and solving the master problem and the sub-problem to obtain an optimization result; and
generating a power grid recovery solution of the new electric power system based on the optimization result.

11. The power grid recovery method of a new electric power system based on a second-order cone transformation of claim 2, wherein an objective function ƒ_{MP} of the master problem is represented by:
$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ {\sum }_{i = 1}^{{N}_{BUS}} ( 1 - {u}_{i , d}^{s} ) {W}_{i , d} \hat{{p}_{i , d}^{s}} + {\sum }_{i = 1}^{{N}_{BUS}} ( {p}_{i , d}^{s} - \hat{{q}_{i , d}^{s}} ) ] ;$$
the added constraint of the sub-problem comprises:
$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s ;$$
$$0 \leq \hat{{p}_{r}^{s}} \leq {\tilde{p}}_{r}^{s} ;$$
$$\{ \begin{matrix}0 \leq \hat{{p}_{i , d}^{s}} \leq {p}_{i , d}^{s} \\ 0 \leq \hat{{q}_{i , d}^{s}} \leq \overline{{q}_{i , d}^{s}}\end{matrix} ;$$
$$\underline{{q}_{i , g}^{s}} \leq \hat{{q}_{i , g}^{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable of the second stage objective function.

12. The power grid recovery method of a new electric power system based on a second-order cone transformation of claim 3, wherein an objective function ƒ_{MP} of the master problem is represented by:
$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] ;$$
the added constraint of the sub-problem comprises:
$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s ;$$
$$0 \leq \hat{{p}_{r}^{s}} \leq {\tilde{p}}_{r}^{s} ;$$
$$\{ \begin{matrix}0 \leq \hat{{p}_{i , d}^{s}} \leq {p}_{i , d}^{s} \\ 0 \leq \hat{{q}_{i , d}^{s}} \leq \overline{{q}_{i , d}^{s}}\end{matrix} ;$$
$$\underline{{q}_{i , g}^{s}} \leq \hat{{q}_{i , g}^{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents at the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.

13. The power grid recovery method of a new electric power system based on a second-order cone transformation of claim 4, wherein an objective function ƒ_{MP} of the master problem is represented by:
$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] ;$$
the added constraint of the sub-problem comprises:
$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s ;$$
$$0 \leq \hat{{p}_{r}^{s}} \leq {\tilde{p}}_{r}^{s} ;$$
$$\{ \begin{matrix}0 \leq \hat{{p}_{i , d}^{s}} \leq {p}_{i , d}^{s} \\ 0 \leq \hat{{q}_{i , d}^{s}} \leq \overline{{q}_{i , d}^{s}}\end{matrix} ;$$
$$\underline{{q}_{i , g}^{s}} \leq \hat{{q}_{i , g}^{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.

14. The power grid recovery method of a new electric power system based on a second-order cone transformation of claim 5, wherein an objective function ƒ_{MP} of the master problem is represented by:
$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ {\sum }_{i = 1}^{{N}_{BUS}} ( 1 - {u}_{i , d}^{s} ) {W}_{i , d} \hat{{p}_{i , d}^{s}} + {\sum }_{i = 1}^{{N}_{BUS}} ( {p}_{i , d}^{s} - \hat{{p}_{i , d}^{s}} ) ] ;$$
the added constraint of the sub-problem comprises:
$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s ;$$
$$0 \leq \hat{{p}_{r}^{s}} \leq {\tilde{p}}_{r}^{s} ;$$
$$\{ \begin{matrix}0 \leq \hat{{p}_{i , d}^{s}} \leq {p}_{i , d}^{s} \\ 0 \leq \hat{{p}_{i , d}^{s}} \leq \overline{{q}_{i , d}^{s}}\end{matrix} ;$$
$$\underline{{q}_{i , g}^{s}} \leq \hat{{q}_{i , g}^{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$${{p}_{i , g}^{s}}^{\hat{}}$$
represents an active output power of the i-th conventional unit in the time period s after the adjustment in the rescheduling stage;
$${{q}_{i , g}^{s}}^{\hat{}}$$
represents a reactive output power of the i-th conventional unit in the time period s after the adjustment in the rescheduling stage;
$${{p}_{r}^{s}}^{ \hat{}}$$
represents an actual active output power of the r-th new energy unit in the time period s after the adjustment in the rescheduling stage;
$${{p}_{i , d}^{s}}^{\hat{}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.

15. The power grid recovery method of a new electric power system based on a second-order cone transformation of claim 6, wherein an objective function ƒ_{MP} of the master problem is represented by:
$${f}_{M P} = min \{ {\sum }_{s = 0}^{{N}_{T}} Δ T [ {\sum }_{j = 1}^{{N}_{B U S}} ( 1 - {u}_{i , d}^{s} ) {W}_{i , d} {p}_{i , d}^{s} , ] + α \} ;$$
an objective function ƒ_{SP} of the sub-problem is represented by:
$${f}_{S P} = {max}_{{y}_{i , g}^{s , j}} min {\sum }_{s = 0}^{{N}_{T}} Δ T [ \begin{matrix}{\sum }_{i = 1}^{{N}_{B U S}} ( 1 - {u}_{i , d}^{s} , ) {W}_{i , d} {{p}_{i , d}^{s}}^{\hat{}} \\ + {\sum }_{i = 1}^{{N}_{B U S}} ( {p}_{i , d}^{s} - {{p}_{i , d}^{s}}^{\hat{}} )\end{matrix} ] ;$$
the added constraint of the sub-problem comprises:
$$max \{ \underline{{p}_{i , g}^{s}} , {p}_{i , g}^{s} - R {m}_{i} Δ T \} \leq {p}_{i , g}^{s} \leq min \{ \overline{{p}_{i , g}^{s}} , {p}_{i , g}^{s} + R {m}_{i} Δ T \} , ∀ g , ∀ s ;$$
$$0 \leq {{p}_{r}^{s}}^{\hat{}} \leq {\tilde{p}}_{r}^{s} ;$$
$$\{ \begin{matrix}0 \leq {{p}_{i , d}^{s}}^{\hat{}} \leq {p}_{i , d}^{s} \\ 0 \leq {{q}_{i , d}^{s}}^{\hat{}} \leq \overline{{q}_{i , d}^{s}}\end{matrix} ;$$
$$\underline{{q}_{i , g}^{s}} \leq {{q}_{i , g}^{s}}^{\hat{}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.

16. The power grid recovery method of a new electric power system based on a second-order cone transformation of claim 7, wherein an objective function ƒ_{MP} of the master problem is represented by:
$${f}_{MP} = min \{ {\sum }_{s = 0}^{{N}_{T}} Δ T [ {\sum }_{i = 1}^{{N}_{BUS}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] ;$$
the added constraint of the sub-problem comprises:
$$max \{ \underline{{p}_{i , g}^{s}} , {p}_{i , g}^{s} - R {m}_{i} Δ T \} \leq {p}_{i , g}^{s} \leq min \{ \overline{{p}_{i , g}^{s}} , {p}_{i , g}^{s} + R {m}_{i} Δ T \} , ∀ g , ∀ s ;$$
$$0 \leq {\hat{p}}_{r}^{s} \leq {\tilde{p}}_{r}^{s} ;$$
$$\{ \begin{matrix}0 \leq {p}_{i , d}^{\hat{s}} \leq {p}_{i , d}^{s} \\ 0 \leq {q}_{i , d}^{\hat{s}} \leq \overline{{q}_{i , d}^{s}}\end{matrix} ;$$
$$\underline{{q}_{i , g}^{s}} \leq {q}_{i , g}^{\hat{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$${q}_{i , d}^{\hat{s}}$$
represents reactive power of the i-th load node in the time periods after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.

17. The power grid recovery method of a new electric power system based on a second-order cone transformation of claim 8, wherein an objective function ƒ_{MP} of the master problem is represented by:
$${f}_{M P} = min \{ {\sum }_{s = 0}^{{N}_{T}} Δ T [ {\sum }_{i = 1}^{{N}_{B U S}} ( 1 - {u}_{i , d}^{s} ) {W}_{i , d} {p}_{i , d}^{s} ] + α \} ;$$
an objective function ƒ_{SP} of the sub-problem is represented by:
$${f}_{SP} = {max}_{{y}_{i , g}^{s , j}} min {\sum }_{s = 0}^{{N}_{T}} Δ T [ \begin{matrix}{\sum }_{i = 1}^{{N}_{BUS}} ( 1 - {u}_{i , d}^{s} ) {W}_{i , d} \hat{{p}_{i , d}^{s}} + \\ {\sum }_{i = 1}^{{N}_{BUS}} ( {p}_{i , d}^{s} - \hat{{p}_{i , d}^{s}} )\end{matrix} ] ;$$
the added constraint of the sub-problem comprises:
$$max \{ \underline{{p}_{i , g}^{s}} , {p}_{i , g}^{s} - {Rm}_{i} Δ T \} \leq {p}_{i , g}^{s} \leq min \{ \overline{{p}_{i , g}^{s}} , {p}_{i , g}^{s} + {Rm}_{i} Δ T \} , ∀ g , ∀ s ;$$
$$0 \leq \hat{{p}_{r}^{s}} \leq {\tilde{p}}_{r}^{s} ;$$
$$\{ \begin{matrix}0 \leq \hat{{p}_{i , d}^{s}} \leq {p}_{i , d}^{s} \\ 0 \leq \hat{{q}_{i , d}^{s}} \leq \overline{{q}_{i , d}^{s}}\end{matrix} ;$$
$$\underline{{q}_{i , g}^{s}} \leq \hat{{q}_{i , g}^{s}} \leq \overline{{q}_{i , g}^{s}} ;$$
wherein, α is an auxiliary variable; Rmᵢ represents a ramp rate of an i-th conventional unit;
$$\overline{{p}_{i , g}^{s}}$$
represents an active output power upper limit of the i-th conventional unit in a time period s;
$$\underline{{p}_{i , g}^{s}}$$
represents an active output power lower limit of the i-th conventional unit in the time period s;
$$\overline{{q}_{i , g}^{s}}$$
represents a reactive output power upper limit of the i-th conventional unit in the time period s;
$$\underline{{q}_{i , g}^{s}}$$
represents a reactive output power lower limit of the i-th conventional unit in the time period s;
$${q}_{i , d}^{s}$$
represents a reactive power of an i-th load node in the time period s;
$$\hat{{q}_{i , d}^{s}}$$
represents a reactive power of the i-th load node in the time period s after an adjustment in a rescheduling stage;
$$\overline{{q}_{i , d}^{s}}$$
represents a reactive output power upper limit of the i-th load node in the time period s; N_{T} represents a number of time periods in a recovery process of the new electric power system, wherein a time length of each time period is ΔT, total recovery time is N_{S}, and it is assumed that a black start unit and a node in which the black start unit is located are recovered at a time 0;
$${u}_{i , b}^{s}$$
represents a state of an i-th bus node in the time period s, wherein a value of 1 for
$${u}_{i , b}^{s}$$
represents that the i-th bus node has recovered, and a value of 0 for
$${u}_{i , b}^{s}$$
represents that the i-th bus node has not recovered;
$${u}_{i , d}^{s}$$
represents a state of the i-th load node in the time period s, wherein a value of 1 for
$${u}_{i , d}^{s}$$
represents that the i-th load node has recovered, and a value of 0 for
$${u}_{i , d}^{s}$$
represents that the i-th load node has not recovered;
$${u}_{i , g}^{s}$$
represents a state of an i-th unit node in the time period s, wherein a value of 1 for
$${u}_{i , g}^{s}$$
represents that the i-th unit node has recovered, and a value of 0 for
$${u}_{i , g}^{s}$$
represents that the i-th unit node has not recovered;
$${u}_{ij , l}^{s}$$
represents whether a line of connection nodes (i, j) is recovered in the time period s, wherein a value of 1 for
$${u}_{ij , l}^{s}$$
represents that the connection nodes (i, j) has recovered, and a value of 0 for
$${u}_{ij , l}^{s}$$
represents that the connection nodes (i, j) has not recovered;
$${p}_{i , g}^{s}$$
represents an active output power of the i-th conventional unit in the time period s in an expected scenario;
$${q}_{i , g}^{s}$$
represents a reactive output power of the i-th conventional unit in the time period s in the expected scenario;
$${p}_{r}^{s}$$
represents an actual active output power of a r-th new energy unit in the time period s;
$${\tilde{p}}_{r}^{s}$$
represents a predicted value of an active output power of the r-th new energy unit in the time period s in the expected scenario; represents an amount of load recovered by the i-th load node in the time period s; W_{i,d} represents a load weight coefficient of the i-th load node;
$$\hat{{p}_{i , g}^{s}}$$
represents an active output power of the i-th conventional unit in the time period s after the adjustment in the rescheduling stage;
$$\hat{{q}_{i , g}^{s}}$$
represents a reactive output power of the i-th conventional unit in the time period s after the adjustment in the rescheduling stage;
$$\hat{{p}_{r}^{s}}$$
represents an actual active output power of the r-th new energy unit in the time period s after the adjustment in the rescheduling stage;
$$\hat{{p}_{i , d}^{s}}$$
represents an amount of load recovered by the i-th load node in the time period s after the adjustment in the rescheduling stage; N_{BUS} represents a total number of bus nodes; and
$${y}_{i , g}^{s , j}$$
is an outer layer optimization variable.
